(19) United States
(12) Patent Application Publication
(10) Pub. No.: US 2024/0038089 A1
(43) Pub. Date: Feb. 1, 2024

(54) INTERACTIVE VIRTUAL LEARNING SYSTEM AND METHODS OF USING SAME

(71) Applicants: Michiyo Anna Maria Kawasaki Fortner, (US); Nathan Lee Fortner, (US)

(72) Inventors: Michiyo Anna Maria Kawasaki Fortner, (US); Nathan Lee Fortner, (US)

(21) Appl. No.: 17/875,604

(22) Filed: Jul. 28, 2022

(51) Int. Cl. G09B 7/04; G09B 7/08; G09B 19/06

(52) U.S. Cl. CPC G09B 7/04; G09B 7/08; G09B 19/06

(57) ABSTRACT

The present disclosure provides interactive audio/video-based systems for teaching a subject to a human user based on, for example, the human user's mastery-indicating input(s), and methods of using same.

### PRIORITY CLAIM

This application is a continuation of U.S. patent application Ser. No. 17/121,746, filed on Dec. 14, 2020, which claims priority to U.S. Provisional Patent Application Ser. No. 62/948,171, filed Dec. 13, 2019, the entire contents of each of which are incorporated herein by reference and relied on.

### FIELD

The present disclosure provides interactive audio/video-based systems for teaching a subject to a human user based on, for example, the human user's mastery-indicating input(s), and methods of using same.

### BACKGROUND

There has been a proliferation of mobile and web-based learning applications, including in the arena of language learning. These learning applications offer key benefits compared to in-person tutors and classes, as well as compared to online tutors and classes. The applications are generally more affordable. They are typically more convenient, in that the user can generally engage with the content at any time and from any place, and with no scheduling required.

While these mobile and web-based learning applications are affordable and convenient, they generally do not capture critical benefits of communication with a person. These benefits include: ample opportunity for the user to practice speaking with a person in real-life situations; opportunity for the user to receive real-time and customized feedback on their speech from a person; real-time adjustments of the learning experience by the teacher; exchanges of culture and non-verbal communication; and general fulfillment of connecting with another person. Merging these benefits with the affordability and convenience of mobile and web-based learning applications would create a valuable learning opportunity for learners in many arenas, including language learning.

A need persists for mobile and/or web-based learning applications that efficiently provide the benefits of learning from a person in real time, while offering the convenience and comfort of a solution that can be accessed anytime, anywhere.

### SUMMARY

The present disclosure provides interactive audio/video-based systems for teaching a subject (e.g., a new language) to a human user based on, for example, the human user's mastery-indicating input(s) to interactive assessments (e.g., questions or prompts) presented by the system, and methods of using same. The systems of the present disclosure provide its users an adaptive learning environment that mimics conversational real-time learning environments—including providing immediate feedback to the user U's spoken inputs—while maintaining the convenience, low cost, and low-stress benefits of a virtual setting.

In some embodiments, the present disclosure provides a computer-implemented method of teaching a subject to a user, the method comprising: providing, by a server, non-linear media content to a computing device associated with the user, wherein the non-linear media content comprises a plurality of media content segments; presenting a first media content segment to the user via a computer-based media player, wherein the first media content segment includes a first subject matter; providing, by the computer-based media player, an interactive assessment (e.g., a prompt) to the user; receiving, by an input capture device associated with the user, at least one mastery-indicating input from the user during or after the step of providing the interactive assessment (e.g., prompt) to the user; assessing, based at least in part on the at least one mastery-indicating input, a level of user mastery of the first subject matter; selecting a subsequent media content segment from the plurality of media content segments based at least in part on the level of user mastery; and presenting the subsequent media content segment to the user via the computer-based media player, wherein the mastery-indicating input comprises a word, phrase, sentence or utterance spoken by the user.

These and other embodiments are described in greater detail below with respect to the accompanying figures.

### BRIEF DESCRIPTION OF THE FIGURES

FIG. 1 shows a schematic view of an interactive virtual learning system consistent with one embodiment of the present disclosure.

FIG. 1A shows a representative illustration of non-linear media content including a plurality of media content segments consistent with one embodiment of the present disclosure.

FIG. 1B shows a representative illustration of non-linear media content including a plurality of media content segments consistent with one embodiment of the present disclosure.

FIG. 1C shows a representative illustration of non-linear media content including a plurality of media content segments consistent with one embodiment of the present disclosure.

FIG. 2A shows a flowchart of a method of teaching a subject to a user consistent with one embodiment of the present disclosure.

FIG. 2B shows a flowchart of a method of teaching a subject to a user consistent with another embodiment of the present disclosure.

FIG. 2C shows a flowchart of a method of teaching a subject to a user consistent with another embodiment of the present disclosure.

FIG. 2D shows a flowchart of a method of teaching a subject to a user consistent with another embodiment of the present disclosure.

FIG. 3 shows a display, or a portion thereof, of a learning module consistent with one embodiment of the present disclosure.

FIG. 4 shows a display, or a portion thereof, of a user-specific display consistent with one embodiment of the present disclosure.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

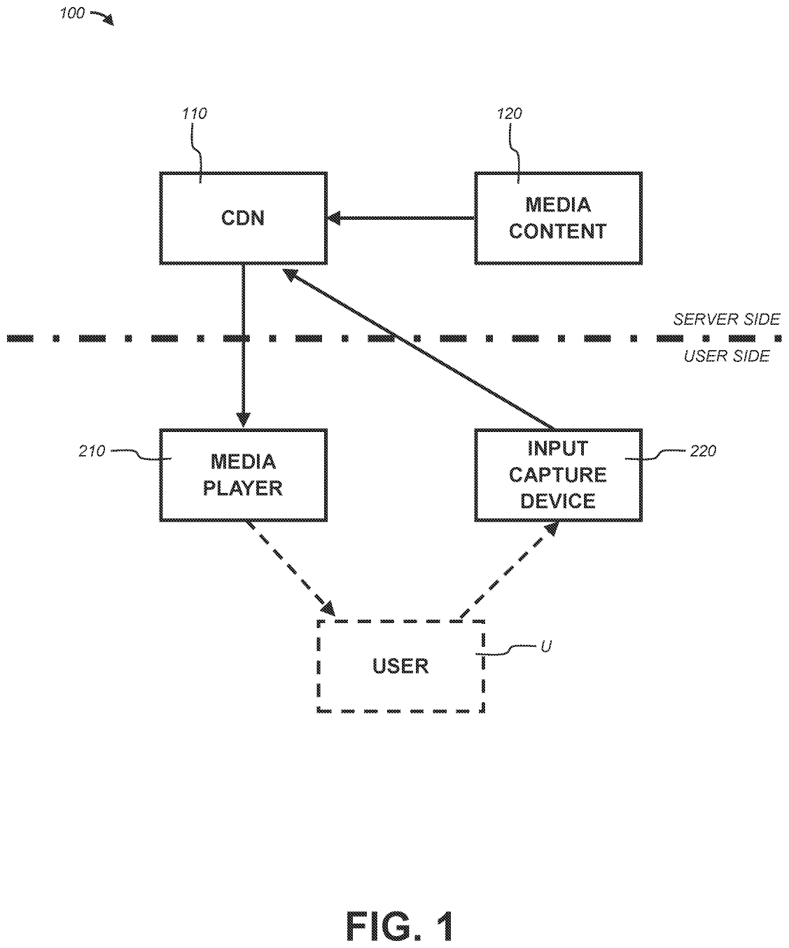

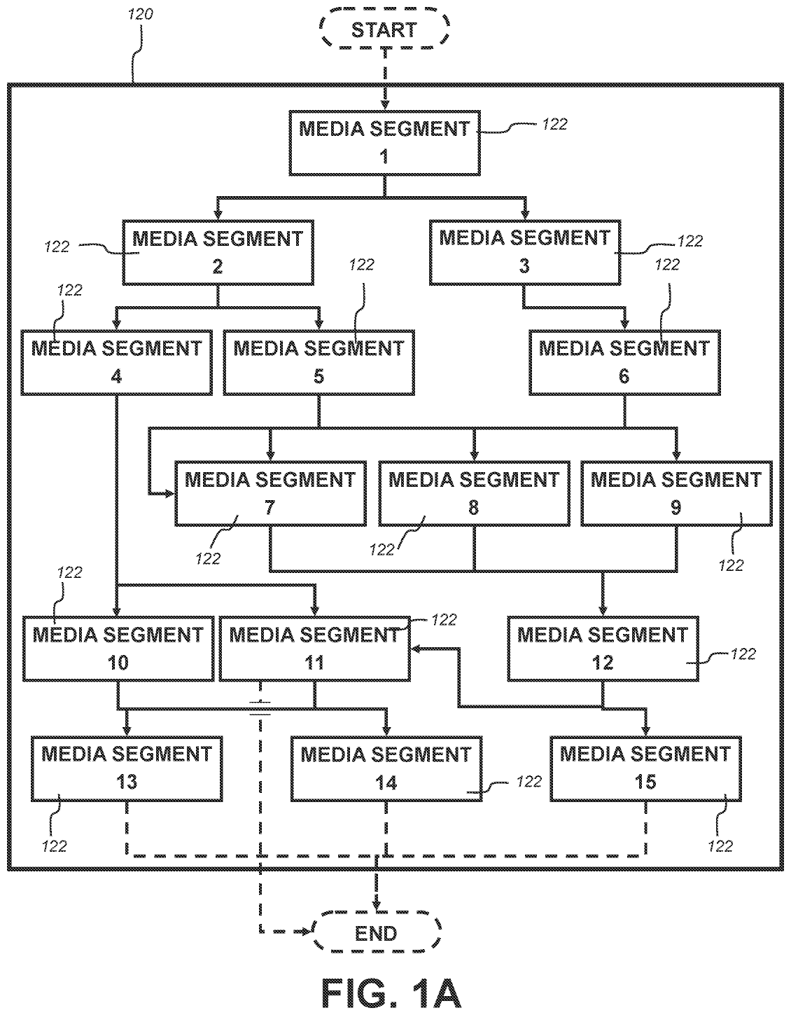

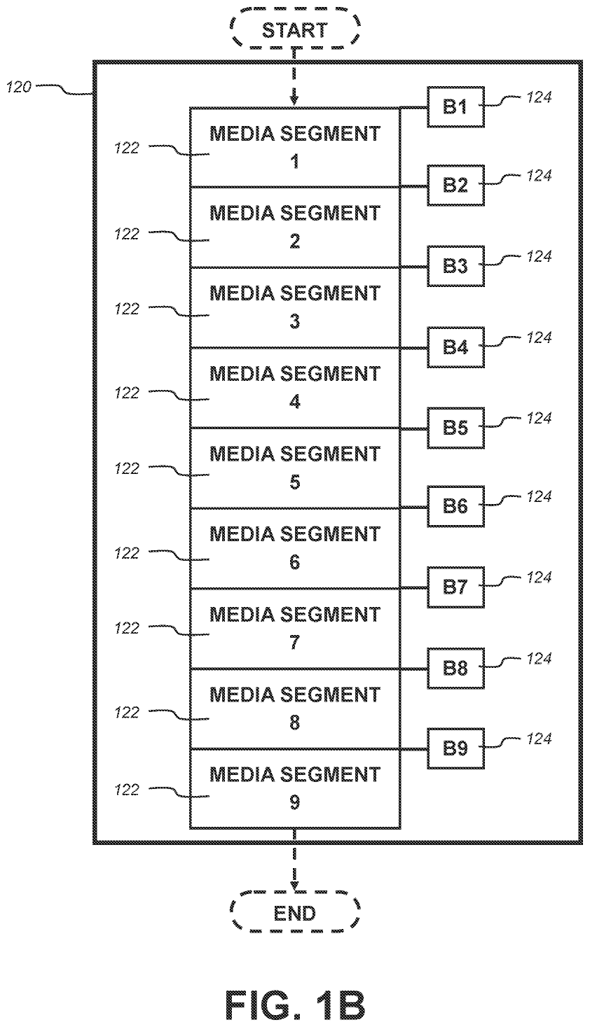

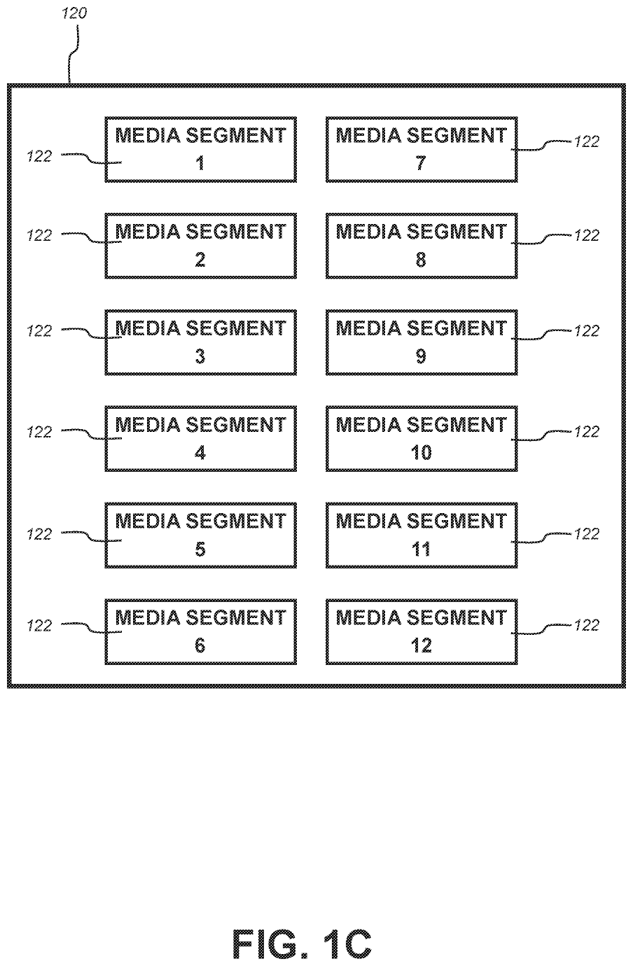

Referring generally to FIGS. 1-4, the present disclosure provides interactive audio/video-based systems for teaching a subject to a human user based on, for example, the human user's mastery-indicating input(s), and methods of using same.

In general, systems 100 consistent with the present disclosure comprise a content delivery network server (“CDN”) 110 for providing media content 120 to a user, a media player 210 configured to provide the media 120 to the user, and an input capture device 220 configured to receive mastery-indicating inputs from the user. The media content 120 may be stored on a server, locally on the user's computing device, or a combination thereof. The media player 210 and the input capture device 220 may be separate devices, or may be housed in a single device, such as a desktop computer, a laptop computer, a mobile device (e.g., a smart phone), a tablet computer, a non-telephonic media player (e.g., an Apple iPod), a smartwatch, a smart speaker, a smart TV, or a headset in operative communication with a computing device.

In general, methods consistent with the present disclosure enable the user U to provide mastery-indicating inputs to interactive assessments (e.g., prompts) that mimic natural conversation with a live person. The mastery-indicating inputs may include a spoken word, a spoken phrase, a spoken sentence, a spoken utterance, a gesture (e.g., with the user U's hand(s)), a facial expression, a sung pitch, a sung word, a sung phrase, etc. In some embodiments, the mastery-indicating input does not require the user U to click a button associated with the computing device, touch a touchscreen of the computing device, or make a selection between options presented by the computing device (e.g., multiple choice type questions that require selection of one choice from a plurality of choice options).

Referring now specifically to FIG. 1, a system 100 consistent with the present disclosure includes at least a content delivery network server (“CDN”) 110 and audio/video content 120 accessible by the CDN 110 on a server side. The term “server side” is used broadly herein, and may refer to a single network, a plurality of distinct networks in communication, and/or a distributed or cloud-based network. The system 100 also includes at least a computer-based media player 210 and an input capture device 220 on a user side. The term “user side” is used broadly herein, and may include a personal computer (e.g., a desktop computer, a laptop computer, a tablet computer, etc.), a mobile device (e.g., a mobile telephone, a smartphone, etc.), a smart television, a non-telephonic media player (e.g., an Apple iPod), a smartwatch, a smart speaker, a smart TV, a headset in operative communication with a computing device, or a combination thereof.

The media content 120 includes non-linear media content. The term “non-linear media content” is used broadly herein, and may include interactive audio and/or video content that is (a) structured hierarchically, for example as a branching media presentation (e.g., as a media tree including one or more nodes, each node including an associated media content segment), (b) structured linearly and includes one or more segments with each segment optionally separated by a preestablished marker or other start/stop indicator, (c) structured as a collection of distinct segments, or (d) structured in any other suitable form.

Referring now to FIG. 1A, the media content 120 in some embodiments is a hierarchically structured media presentation including one or more media content segments 122. The hierarchical structure may be linear, branched, or a combination thereof. For example and without limitation, the non-linear media content 120 shown representatively in FIG. 1A includes fifteen media content segments 122 organized hierarchically. The media player 210 provides the media content 120 beginning at media segment 1. At the conclusion of media segment 1, the media player 210 will play either media segment 2 or media segment 3, for example based at least in part on a user's mastery-indicating input captured by the input capture device 220. The media player 210 continues to provide the media content 120 to the user by following the illustrated paths until, in this example, provision of media content 13, media content 14, or media content 15 is completed.

Referring now to FIG. 1B, the media content 120 in some embodiments includes a plurality of media content segments 122 that are structured linearly, and in some embodiments includes preestablished markers 124, for example associated with the beginning of each media content segment 122. Playback of the linear media content 120 by the media player 210 in these embodiments is non-linear. For example, the media player 210 provides the media content 120 beginning at one preestablished marker 124 (at marker “B1” associated with the beginning of media segment 1 in the illustrated example). At or near the conclusion of playback of the first media content segment 122 by the media player 210, the media player 210 will present an interactive assessment to the user U via the media player 210. Based at least in part on the mastery-indicating input provided by the user U in response to the interactive assessment (e.g., via the input capture device 220), the system 100 will cause the media player 210 to play a subsequent media content segment 122 beginning at its corresponding marker 124. In some embodiments, the preestablished markers 124 are associated with a time code associated with normal-speed playback of the media content 120.

For example, the media content 120 shown representatively in FIG. 1B may begin playback (via the media player 210) at marker B1 of media segment 1. At or near the end of playback of media segment 1, the media player 210 may provide an interactive assessment to the user U via the media player 210. The interactive assessment may be incorporated within media segment 1, or may alternatively be a second media content segment 122 presented by the media player 210 to the user U. After the interactive assessment is presented to the user U by the media player 210, the user U provides a mastery-indicating input to the system 100 via the input capture device 220. The mastery-indicating input may be, for example, a spoken word, phrase, sentence or utterance that responds to the subject matter of the interactive assessment. Based at least in part on the mastery-indicating input provided by the user U (optionally in combination with demographic information associated with the user U, individual cumulative mastery value(s), and/or individual cumulative mastery probability(ies) described more fully below), the system 100 selects a subsequent media content segment 122 to present to the user U via the media player 210, for example media segment 4 beginning at its associated marker B4. The cycle of playback of a media content segment 122 beginning at its associated marker 124, presentation of an interactive assessment to the user U, capture of a mastery-indicating input via the input capture device 220, and selection and playback of a subsequent media content segment 124 continues until presentation of the media content 120 to the user U concludes.

Referring now to FIG. 1C, the media content 120 in some embodiments includes a plurality of media content segments 122 that are each structured as distinct linear media content files. The media player 210 provides the media content 120 to the user by providing one linear media segment 122 at a time and in an order determined by the CDN 110, based at least in part on the mastery-indicating inputs provided by the user U in response to interactive assessments.

Each media content segment 122 comprises at least one subject matter. The subject matters of various media content segments 122 may be the same, similar, or different from each other, but typically the collection of media content segments 122 that comprise the media content 120 will include a plurality of different subject matters including interactive assessments and user feedback.

In general, and specifically relating to methods including playback of non-linear media content 120 shown representatively in FIGS. 1A-1C, the CDN 110 selects a first media content segment 122 of the media content 120 (e.g., media content segment 122 identified as “media segment 3” in any of FIGS. 1A-1C) to be played by the media player 210. The selected media content segments 122 of the media content 120 are transmitted by the CDN 110 to the media player 210. During or after each selected media content segment 122 is presented to the user by the media player 210, the input capture device 220 receives a mastery-indicating input from the user. The mastery-indicating input is processed by the system 100 (e.g., by the CDN 110 and/or by a user-side computing device associated with the input capture device 220) to determine which media content segment 122 to provide to the user next, optionally based on additional factors such as demographic information associated with the user.

In some embodiments, for example, the selection of the subsequent media content segment 122 to provide to the user is determined based on a level of user mastery of the subject matter featured in the selected media content segment 122. If the mastery-indicating input indicates that the user has mastered the subject matter, the CDN 110 selects a subsequent media content segment 122 that, for example, provides positive feedback to the user and/or builds on the mastered subject matter. If the mastery-indicating input indicates that the user has not mastered the subject matter, the CDN 110 selects a different subsequent media content segment 122 that, for example, reinforces (e.g., reviews, reteaches, or teaches in an alternative manner) the subject matter of the initial selected media content segment 122.

The terms “masterful learning” and “mastery” are used broadly herein to refer to a user's substantial understanding of subject matter presented to the user in a media content segment. For example, if understanding of a particular subject was assessed mathematically, “mastery” may represent a user's achievement of at least about 60% of the subject matter, for example at least about 60% of the subject matter, at least about 65% of the subject matter, at least about 70% of the subject matter, at least about 75% of the subject matter, at least about 80% of the subject matter, at least about 85% of the subject matter, at least about 90% of the subject matter, at least about 95% of the subject matter, or about 100% of the subject matter. In some embodiments, the minimum required user achievement level to qualify as “mastery” may be determined at least in part by a user input preference. In some embodiments, the minimum required user achievement level to qualify as “mastery” may vary from media content segment to media content segment. In some embodiments, the minimum required user achievement level to qualify as “mastery” is relatively low for media content segments provided to the user early on, and relatively higher for media content segments provided to the user later on.

In some embodiments, a step of assessing user mastery comprises determining a confidence score associated with the user U's mastery-indicating input. For example and without limitation, the confidence score may include an accuracy index associated with a comparison of an automatic speech recognition (“ASR”) (e.g., speech-to-text, Kaldi ASR, or other ASR modeling) interpretation of the user U's spoken mastery-indicating input to a benchmark (text or image or other) of a perfect comparative input. In such embodiments, the confidence score is relatively high when the ASR interpretation of the user U's spoken mastery-indicating input matches or nearly matches the perfect comparative input. For example, the determined confidence score is high if the user U's mastery-indicating input causes the generation of an ASR interpretation of “Yes I would love some ice cream” and the perfect comparative input is “Yes I would love some ice cream,” but the determined confidence score is relatively low if the user U's mastery-indicating input causes the generation of an ASR of “Yes I would love some yogurt” and the perfect comparative input is “Yes I would love some ice cream.”

In other embodiments, the confidence score may include an accuracy index associated with a comparison of an ASR interpretation of the user U's spoken mastery-indicating input to a benchmark (text or image or other) of a common incorrect comparative input. In such embodiments, the confidence score is relatively low when the ASR interpretation of the user U's spoken mastery-indicating input matches or nearly matches the common incorrect comparative input. For example, the determined confidence score is relatively low if the user U's mastery-indicating input causes the generation of an ASR interpretation of “Yes I could love some ice cream” and the common incorrect comparative input is “Yes I could love some ice cream.”

In other embodiments, the confidence score may include an accuracy index associated with a comparison of an ASR interpretation of the user U's spoken mastery-indicating input to a benchmark (text or image or other) of an unnecessary response comparative input. In such embodiments, the confidence score is relatively low when the ASR interpretation of the user U's spoken mastery-indicating input matches or nearly matches the unnecessary response comparative input. For example, the determined confidence score is relatively low if the user U's mastery-indicating input causes the generation of an ASR interpretation of “Yo quiero tamales” and the unnecessary response comparative input is “Yo quiero tamales” (e.g., when the perfect comparative input is “Quiero tamales”).

In some embodiments, selection of the subsequent media content segment 122 contains user feedback that is based at least in part on the confidence score. For example, if the confidence score is relatively high, the subsequent media content segment 122 provided to the user U may include feedback such as “That was excellent!” whereas the subsequent media content segment 122 provided to the user U may include feedback such as “Sounds like we should practice a bit more” if the confidence score is relatively low, or “That's not bad” if the confidence score is about average.

In some embodiments, “mastery” may be gauged qualitatively or semi-quantitatively. For example, in some embodiments assessing the user U's “mastery” comprises determining whether the user U understands the subject matter relatively well or relatively poorly, rather than quantifying the user U's achievement.

In some embodiments, assessing a user's mastery of subject matter presented in a selected segment includes presenting an interactive assessment (e.g., a prompt) to the user. The interactive assessment is generally presented to the user at or near the end of the selected segment. The interactive assessment may be any type of communication presented by the media player 210 that invites the user U to provide a mastery-indicating input (e.g., a response) to the system 100, for example via the input capture device 220. For example and without limitation, the interactive assessment may include an open-ended question; a dichotomous question (e.g., a yes/no question or an A/B choice question); a prompt to choose between three or more options; a rank order question; a Likert scale question, a semantic differential scale question; a demographic question; a request to translate a word, phrase or sentence from one language to another; a portion of a conversation requiring a response; a request to repeat a word, phrase or sentence spoken in the interactive assessment; and/or a prompt to provide a mastery-indicating input to a previous interactive assessment (e.g., a prompt asking the user to try again). The interactive assessment may also include statements without an inquiry component, such as conversational phrases and sentences that invite a conversational response without posing a question, such as “The weather seems to be improving lately” or “That movie was not very entertaining.”

During and/or after presentation of the interactive assessment by the media player 210, the input capture device 220 captures one or more mastery-indicating inputs from the user U, such as a spoken word or phrase or sentence, a gesture, and/or a facial expression. The mastery-indicating input is processed by the system 100 (e.g., by the CDN 110 and/or by a user-side computing device associated with the input capture device 220) to assess a level of user mastery of the subject matter featured in the selected segment.

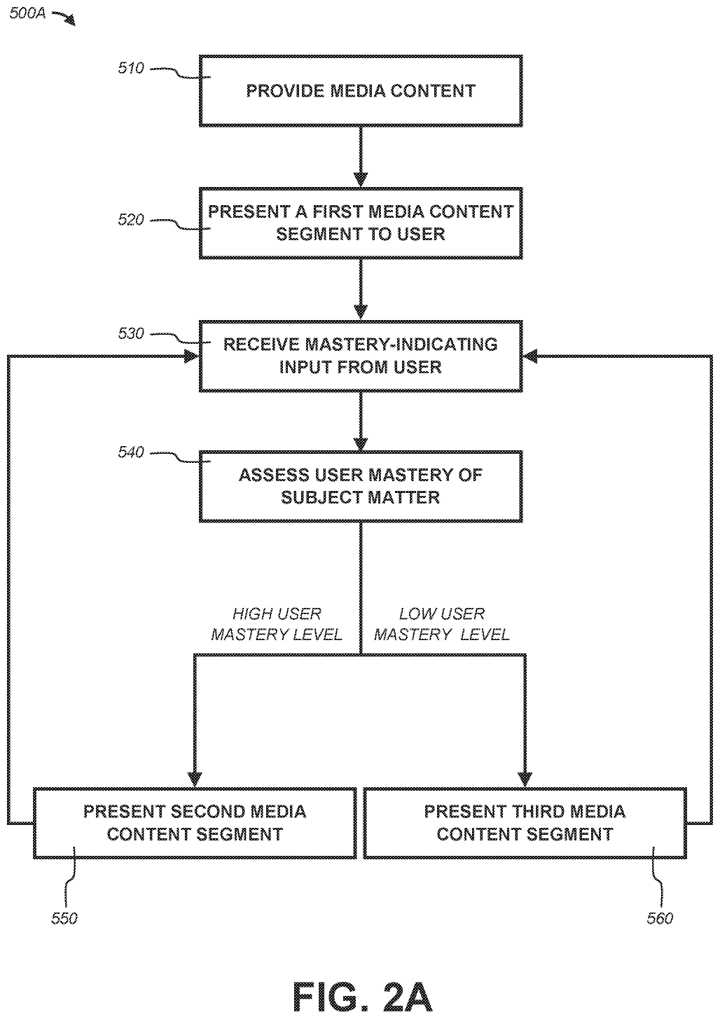

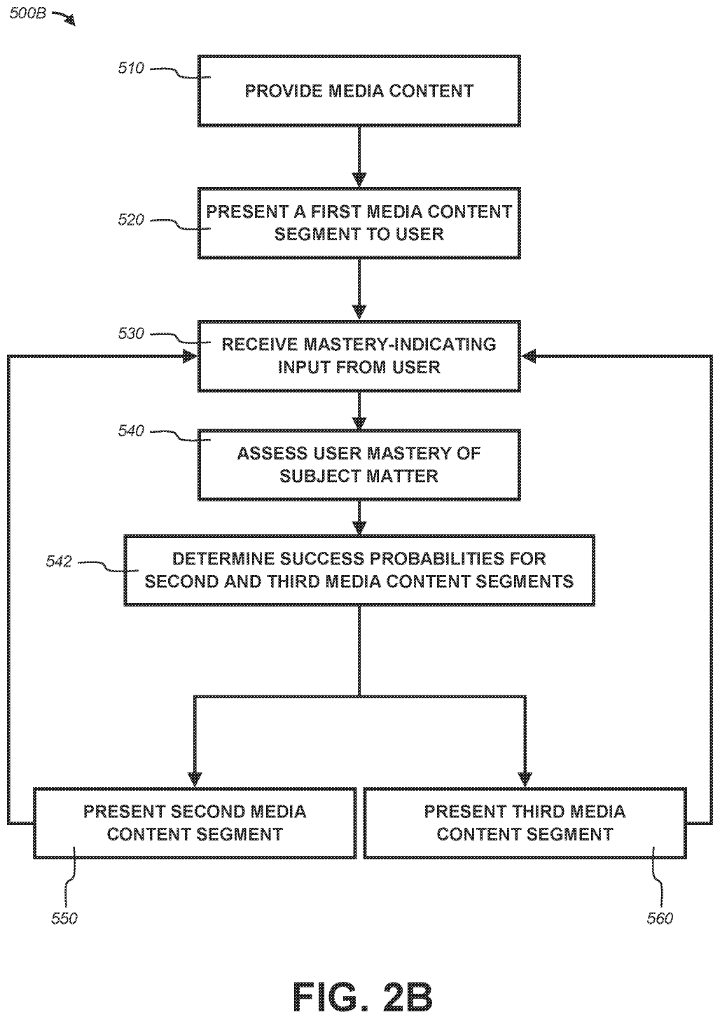

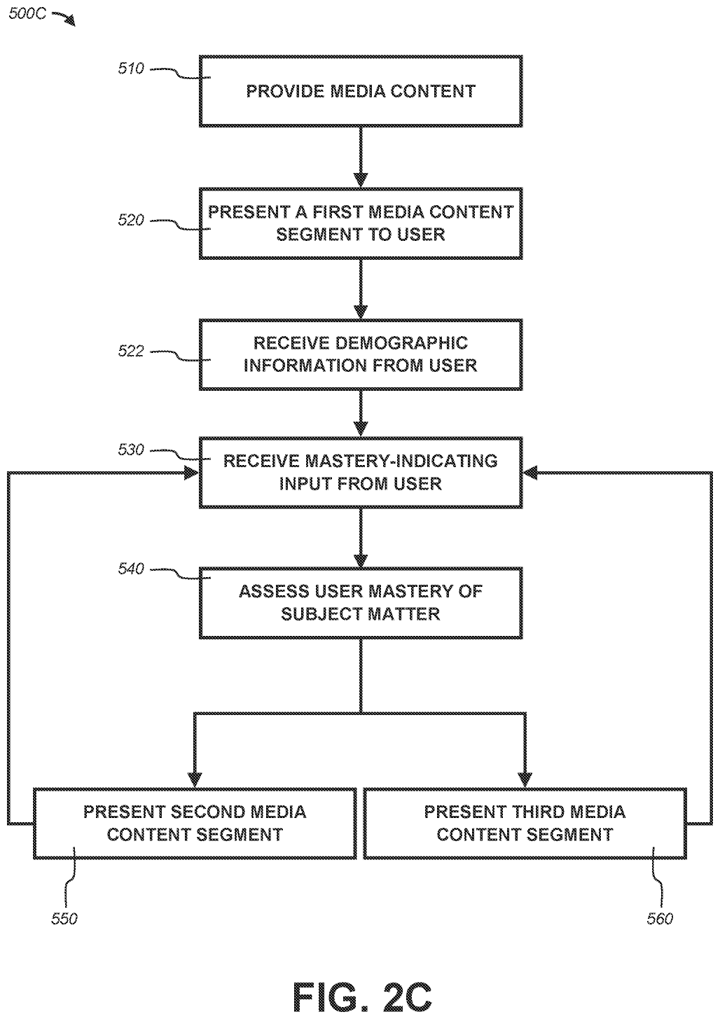

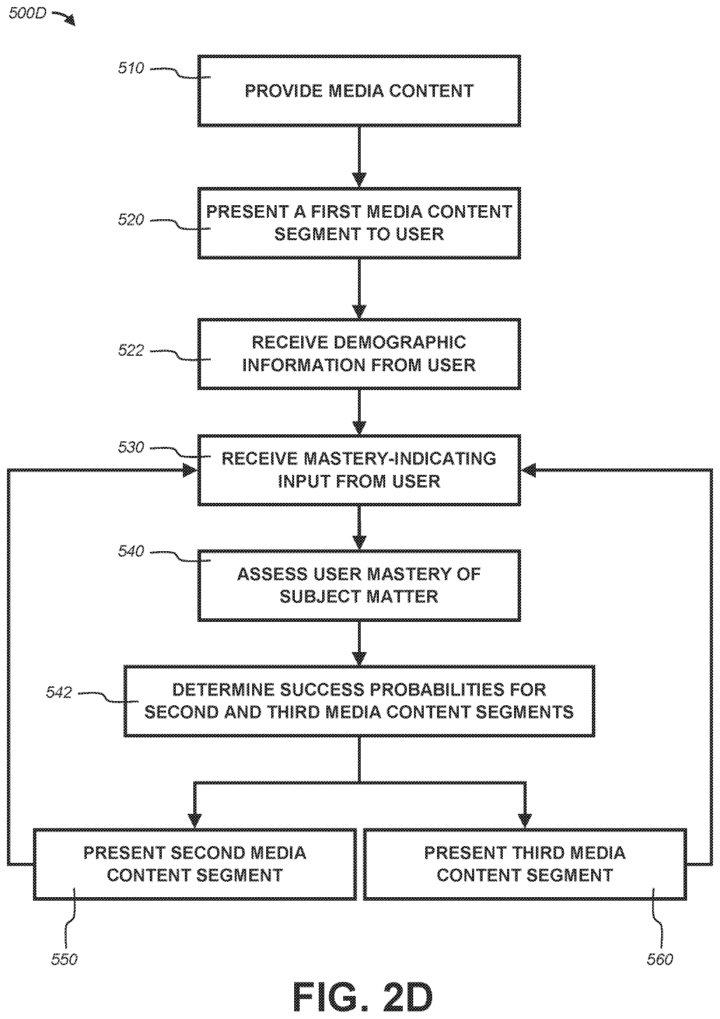

Referring now specifically to FIG. 2A, a computer-implemented method 500A of teaching a subject to a user U consistent with some embodiments of the present disclosure comprises providing, in step 510, by a server (e.g., CDN 110), media content 120 to a computing device associated with the user U. The media content 120 in some embodiments comprises a plurality of non-linear media content segments 122. The method 500A further comprises presenting, in step 520, a first media content segment to the user U via a computer-based media player 210. The first media content segment includes a first subject matter. The method 500A further comprises receiving, in step 530, by an input capture device 220 associated with the user U, at least one mastery-indicating input from the user U during or after the step of presenting the first media content segment. The method 500A further comprises assessing, in step 540, a level of user mastery of the first subject matter based on the at least one mastery-indicating input. The method 500A further comprises presenting, in step 550, a second media content segment to the user U if the step 540 of assessing indicates a relatively high level of user mastery of the first subject matter of the first media content segment, or presenting, in step 560, a third media content segment to the user U if the step of assessing indicates a relatively low level of user mastery of the first subject matter of the first media content segment. The second media content segment includes a second subject matter; and the third media content segment includes a third subject matter that is different from the second subject matter.

In some embodiments of this method 500A, the step 510 of providing media content comprises transmitting the media content from the server (e.g., from CDN 110) to a storage component associated locally with the computer-based media player 210. In such embodiments, the step 520 of presenting the first media content segment to the user U comprises causing the computer-based media player 210 to retrieve the first media content segment from the local storage component. In such embodiments, the system 100 is enabled to present media content segments to the user U via media player 210 even if the media player 210 cannot communicate with the server (e.g., CDN 110), for example if the computing device is unable to connect to the server via wireless protocol.

In other embodiments of this method 500A, the step 520 of presenting the first media content segment to the user U comprises causing the computer-based media player 210 to retrieve the first media content segment from the server (e.g., from CDN 110). In such embodiments, the system 100 is enabled to cause the media player 210 to present any media content segment to the user U so long as the media content player 210 can communicate with the server (e.g., CDN 110).

In some embodiments of this method 500A, the second subject matter is different from the first subject matter, and the third subject matter is different from the first subject matter.

In some embodiments of this method 500A, one of the second subject matter and the third subject matter is the same as the first subject matter.

In some embodiments of this method 500A, the second media content segment and the third media content segment are selected from a plurality of media content segments based at least in part on the level of user mastery of the first subject matter.

In some embodiments of this method 500A, the mastery-indicating input(s) comprises an individual real-time mastery factor. Generally, the individual real-time mastery factor is associated with the user U's mastery of the first subject matter. For example, a component of (or the entire) individual real-time mastery factor may be the length of time between presentation of an interactive assessment (e.g., a prompt) to the user U (e.g., presentation of a media content segment 122 that includes a question to the user U via the media player 210) and receipt of a user mastery-indicating input (e.g., by the input capture device 220) that corresponds to a mastery-indicating input (e.g., an attempted prompt response or a correct prompt response, such as a spoken word, a spoken phrase, a spoken utterance, a gesture, and/or a facial expression). The mastery-indicating input need not be a correct response to the interactive assessment; in some embodiments the time between presentation of the interactive assessment and any attempted mastery-indicating input by the user U provides useful information relevant to the user U's real-time mastery of the presented subject matter. In another non-limiting example, a component of (or the entire) individual real-time mastery factor may be the number of user mastery-indicating inputs (e.g., received by the input capture device 220) that correspond to incorrect mastery-indicating input to the interactive assessment before a user mastery-indicating input corresponding to a correct mastery-indicating input is received by the input capture device 220. In yet another non-limiting example, a component of (or the entire) individual real-time mastery factor may be the fraction of a user mastery-indicating input (e.g., spoken input or text input received by the input capture device 220) that corresponds to a comparative response (e.g., a correct response or a series of expected responses). In still another non-limiting example, a component of (or the entire) individual real-time mastery factor may be the receipt (e.g., by the input capture device 220) of a mastery-indicating input that includes an audio input that corresponds to a sound or spoken expression associated with human uncertainty. Generally, receipt (e.g., by the input capture device 220) of a relatively high number of sounds or spoken expressions that are associated with human uncertainty indicate that the user U has not mastered the presented subject matter, while receipt of a relatively low number of sounds or spoken expressions that are associated with human uncertainty indicate that the user U has mastered the presented subject matter. In some embodiments the user U's baseline level of sounds and/or spoken expressions associated with human uncertainty (e.g., a frequency of such words uttered during the user U's normal speech) may be determined, and the frequency of sounds and spoken expressions associated with human uncertainty in response to an interactive assessment (e.g., a prompt) may be compared to the user U's baseline frequency level to determine (at least in part) the individual real-time mastery factor. Sounds or spoken expressions associated with human uncertainty vary from language to language; non-limiting examples include words or sounds that indicate speech disfluency such as (in English) “um,” “uh,” “erm,” and the like. In still another non-limiting example, a component of (or the entire) individual real-time mastery factor may be the receipt (e.g., by the input capture device 220) of a mastery-indicating input including an audio input corresponding to a sound or spoken expression associated with human certainty. Generally, receipt (e.g., by the input capture device 220) of a relatively high number of sounds or spoken expressions that are associated with human certainty indicate that the user U has mastered the presented subject matter, while receipt of a relatively low number of sounds or spoken expressions that are associated with human certainty indicate that the user U has not mastered the presented subject matter. In some embodiments the user U's baseline level of sounds and/or spoken expressions associated with human certainty (e.g., a frequency of such words uttered during the user U's normal speech) may be determined, and the frequency of sounds and spoken expressions associated with human certainty in response to an interactive assessment (e.g., a prompt) may be compared to the user U's baseline frequency level to determine (at least in part) the individual real-time mastery factor. Sounds or spoken expressions associated with human certainty vary from language to language; non-limiting examples include words or sounds such as (in English) “oh!” “I know that,” “aha!,” “yes,” and the like. In still another non-limiting example, a component of (or the entire) individual real-time mastery factor may be the receipt (e.g., by the input capture device 220) of a mastery-indicating input (e.g., a fraction of an image) that includes a facial expression or physical motion associated with human uncertainty. Generally, receipt or capture (e.g., by the input capture device 220) of a relatively high number of images or motions associated with human uncertainty indicate that the user U has not mastered the presented subject matter, while receipt or capture of a relatively low number of images or motions associated with human uncertainty indicate that the user U has mastered the presented subject matter. In some embodiments the user U's baseline level of facial expressions and motions associated with human uncertainty (e.g., a frequency of such expressions and motions emitted during normal speech) may be determined, and the frequency of expressions and motions associated with human uncertainty in response to an interactive assessment (e.g., a prompt) may be compared to the user U's baseline frequency level to determine (at least in part) the individual real-time mastery factor. Expressions and motions associated with human uncertainty vary from culture to culture; non-limiting examples in Western culture include a furrowed brow, a frown, a cringe, one or more hands contacting the forehead, one or more fingers running through one's hair, one's chin lowered to touch or nearly touch one's chest, and the like. In still another non-limiting example, a component of (or the entire) individual real-time mastery factor may be the receipt (e.g., by the input capture device 220) of a mastery-indicating input (e.g., a fraction of an image) including a facial expression or physical motion associated with human certainty. Generally, receipt or capture (e.g., by the input capture device 220) of a relatively high number of images or motions associated with human certainty indicate that the user U has mastered the presented subject matter, while receipt or capture of a relatively low number of images or motions associated with human certainty indicate that the user U has not mastered the presented subject matter. In some embodiments the user U's baseline level of facial expressions and motions associated with human certainty (e.g., a frequency of such expressions and motions emitted during normal speech) may be determined, and the frequency of expressions and motions associated with human certainty in response to an interactive assessment (e.g., a prompt) may be compared to the user U's baseline frequency level to determine (at least in part) the individual real-time mastery factor. Expressions and motions associated with human certainty vary from culture to culture; non-limiting examples in Western culture include a smile, a nod of the head, arms raised above the head, relaxed shoulder profile, and the like. In another non-limiting example, a component of (or the entire) individual real-time mastery factor may be whether the user U provided a mastery-indicating input (e.g., by the input capture device 220) that is accurate (e.g., has a high confidence score) without the user U requesting assistance (e.g., without clicking a “show me the answer” button). In another non-limiting example, a component of (or the entire) individual real-time mastery factor may be a quantitative or semiquantitative determination of variations in the user U's vocal amplitude within a single spoken mastery-indicating input (e.g., as an indicator of the user U's confidence or certainty while providing the mastery-indicating input). In another non-limiting example, a component of (or the entire) individual real-time mastery factor may be a real-time assistance factor associated with whether and/or the number of times and/or frequency at which the user U requests for assistance (e.g., selects “show me the answer” before providing a mastery-indicating input). Generally, a request for assistance indicates that the user U has not mastered the presented subject matter; multiple requests for assistance before providing a mastery-indicating input generally suggests that the user U has a low level of mastery associated with the presented subject matter.

In some embodiments of this method 500A, the mastery-indicating input(s) comprises an individual cumulative mastery factor. The individual cumulative mastery factor, in some embodiments, includes a cumulative individual real-time mastery probability based on all of the user U's previous individual real-time mastery factors. In other embodiments, the individual cumulative mastery factor includes a cumulative individual real-time mastery probability that is calculated based on any one individual real-time mastery factor, or on any two or more individual real-time mastery factors. In still other embodiments, the individual cumulative mastery factor includes a cumulative learning exposure frequency that is calculated based on a number of times the user U has been presented the first subject matter. In still other embodiments, the individual cumulative mastery factor includes a cumulative learning exposure duration based on a length of time the user U has been presented the first subject matter. In still other embodiments, the individual cumulative mastery factor includes a length of time since the user U was last presented the first subject matter. In still other embodiments, the individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In still other embodiments, the individual cumulative mastery factor includes a cumulative individual real-time mastery probability that is calculated based on any one individual real-time mastery factor occurring within a predetermined time, such as within the past day, within the past week, within the past two weeks, within the past month, or within the past two months. In still other embodiments, the individual cumulative mastery factor includes a cumulative individual real-time mastery probability that is calculated based on any two or more individual real-time mastery factors occurring within a predetermined time, such as within the past day, within the past week, within the past two weeks, within the past month, or within the past two months. In still other embodiments, the individual cumulative mastery factor includes a cumulative learning exposure frequency based on a number of times the user U has been presented the first subject matter within a predetermined time, such as within the past day, within the past week, within the past two weeks, within the past month, or within the past two months. In some embodiments, the individual cumulative mastery factor includes a cumulative assistance factor associated with the number of times and/or frequency at which the user U requests for assistance (e.g., selects “show me the answer” before providing a mastery-indicating input). Generally, numerous requests for assistance and high frequencies of requests for assistance each indicate that the user U has not mastered the presented subject matter; multiple requests for assistance before providing a mastery-indicating input generally suggests that the user U has a low level of mastery associated with the presented subject matters. In some embodiments, the individual cumulative mastery factor includes any two or more of the foregoing, or all of the foregoing, or a measure of the level of change in demonstrated mastery of the first subject matter over time.

Referring now specifically to FIG. 2B, a computer-implemented method 500B of teaching a subject to a user U comprises a step 510 of providing, by a server (e.g., CDN 110), media content 120 to a computing device associated with the user U. The media content 120 in some embodiments comprises a plurality of non-linear media content segments 122. The method 500B further comprises presenting, in step 520, a first media content segment to the user U via a computer-based media player 210. The first media content segment includes a first subject matter. The method 500B further comprises receiving, in step 530, by an input capture device 220 associated with the user U, at least one mastery-indicating input from the user U during or after the step of presenting the first media content segment. The method 500B further comprises assessing, in step 540, a level of user mastery of the first subject matter based on the at least one mastery-indicating input. These steps 510, 520, 530, and 540 operate in substantially the same way in this method 500B as described above with respect to method 500A shown representatively in FIG. 2A.

In some embodiments of this method 500B, the second subject matter is different from the first subject matter, and the third subject matter is different from the first subject matter.

In some embodiments of this method 500B, one of the second subject matter and the third subject matter is the same as the first subject matter.

The method 500B further comprises determining, in step 542, a success probability associated with the user U for a second media content segment including a second subject matter, and a success probability associated with the user U for a third media content segment including a third subject matter.

In some embodiments, the step 542 of determining the success probability associated with the user for the second media content segment comprises determining an individual success probability factor associated with the user U for subject matter of the second media content segment (i.e., the second subject matter), and determining an individual success probability factor associated with the user U for subject matter of the third media content segment (i.e., the third subject matter).

In some embodiments, the individual success probability factor associated with the user for the subject matter of the second media content segment comprises a second individual cumulative mastery factor, and the individual success probability factor associated with the user for the subject matter of the third media content segment comprises a third individual cumulative mastery factor. The second or third individual cumulative mastery factor, in some embodiments, includes a cumulative individual real-time mastery probability based on all of the user U's previous individual real-time mastery factors associated with the second subject matter or the third subject matter, respectively. In some embodiments, the second or third individual cumulative mastery factor includes a cumulative individual real-time mastery probability based on any one individual real-time mastery factor, or on any two or more individual real-time mastery factors. In some embodiments, the second or third individual cumulative mastery factor includes a length of time since the user U was last presented the second subject matter or the third subject matter, respectively. In some embodiments, the second or third individual cumulative mastery factor includes a cumulative learning exposure frequency based on a number of times the user U has been presented the second subject matter or the third subject matter, respectively. In some embodiments, the second or third individual cumulative mastery factor includes a cumulative learning exposure duration based on a length of time the user U has been presented the second subject matter or the third subject matter, respectively. In some embodiments, the second or third individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In some embodiments, the second or third individual cumulative mastery factor includes a cumulative individual real-time mastery probability based on any one individual real-time mastery factor occurring within a predetermined time, such as within the past day, within the past week, within the past two weeks, within the past month, or within the past two months. In some embodiments, the second or third individual cumulative mastery factor includes a cumulative individual real-time mastery probability based on any two or more individual real-time mastery factors occurring within a predetermined time, such as within the past day, within the past week, within the past two weeks, within the past month, or within the past two months. In some embodiments, the second or third individual cumulative mastery factor includes a cumulative learning exposure frequency based on a number of times the user U has been presented the second subject matter or the third subject matter, respectively, within a predetermined time, such as within the past day, within the past week, within the past two weeks, within the past month, or within the past two months. In some embodiments, the second or third individual cumulative mastery factor includes an improvement factor based on the level of change in the user U's demonstrated mastery of the second subject matter or the third subject matter, respectively. In some embodiments, the second or third individual cumulative mastery factor includes any two or more of the foregoing, or all of the foregoing.

In some embodiments of this method 500B, the individual success probability factor associated with the user U for subject matter of the second media content segment or the third media content segment comprises a cumulative individual mastery value based on all of the user U's previous individual real-time mastery factors associated with the subject matter of the second media content segment or the third media content segment, respectively. In some embodiments, the individual success probability factor associated with the user U for subject matter of the second media content segment or the third media content segment comprises a cumulative individual mastery value based on any one individual real-time mastery factor or on any two or more individual real-time mastery factors. In some embodiments, the individual success probability factor associated with the user U for subject matter of the second media content segment or the third media content segment comprises a cumulative learning exposure frequency based on a number of times the user U has been presented the second subject matter or the third subject matter, respectively. In some embodiments, the individual success probability factor associated with the user U for subject matter of the second media content segment or the third media content segment comprises a cumulative individual real-time mastery value based on the user U's previous individual real-time mastery factors occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative individual mastery value based on any one individual real-time mastery factor occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative individual mastery value based on any two or more individual real-time mastery factors occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative learning exposure frequency based on a number of times the user U has been presented the second subject matter or the third subject matter within a predetermined time, such as within the past day, within the past week, within the past two weeks, within the past month, or within the past two months. In some embodiments, the individual success probability factor associated with the user U for subject matter of the second media content segment or the third media content segment includes any two or more of the foregoing, or all of the foregoing.

In some embodiments of this method 500B, the step 542 of determining the success probability associated with the user U for the second media content segment or the third media content segment comprises determining a collective success probability factor for the user U associated with subject matter of the second media content segment or the third media content segment, respectively. In general, the collective success probability factor associated with the subject matter of the second media content segment (i.e., the second subject matter) reflects a probability that the user U will master the second subject matter (e.g., the user U will provide one or more mastery-indicating inputs via input capture device 220 that demonstrate the user U's mastery of the second subject matter) after the second subject matter is presented to the user U (e.g., via media player 210) the first time. Similarly, the collective success probability factor associated with the subject matter of the third media content segment (i.e., the third subject matter) reflects a probability that the user U will master the third subject matter (e.g., the user U will provide one or more mastery-indicating inputs via input capture device 220 that demonstrate the user U's mastery of the third subject matter) after the third subject matter is presented to the user U (e.g., via media player 210) the first time.

In some embodiments of this method 500B, the collective success probability factor for the user U associated with the subject matter of the second media content segment or the third media content segment is based at least in part on a difficulty factor associated with the second subject matter or the third subject matter, respectively. In some embodiments, the difficulty factor is an initial difficulty factor based at least in part on a number of syllables of the second subject matter or the third subject matter, respectively. In some embodiments, the difficulty factor is an initial difficulty factor based at least in part on a number of letters of the second subject matter or the third subject matter, respectively. In some embodiments, the difficulty factor is an initial difficulty factor based at least in part on a frequency of usage of the second subject matter or the third subject matter, respectively, in common usage. In some embodiments, the difficulty factor is an initial difficulty factor based on any two or more of the foregoing, or all of the foregoing.

In some embodiments of this method 500B, the difficulty factor is a cumulative difficulty factor based at least in part on a mastery success rate associated with a plurality of other users exposed to the second subject matter or the third subject matter, respectively.

The method 500B further comprises, in step 550, of presenting the second media content segment to the user U or, in step 560, presenting the third media content segment to the user U based at least in part on the level of user mastery of the first subject matter, the success probability associated with the user for the second media content segment, and the success probability associated with the user for the third media content segment.

In some embodiments of this method 500B, the second media content segment and the third media content segment are selected from a plurality of media content segments based at least in part on the level of user mastery of the first subject matter, the success probability associated with the user for the second subject matter, the success probability associated with the user for the third subject matter and the success probability associated with the user for each of the plurality of subject matters.

In some embodiments, the server (e.g., CDN 110) selects the second media content segment instead of the third media content segment for presentation to the user U if the success probability associated with the second media content segment is greater than the success probability associated with the third media content segment. Alternatively, the server (e.g., CDN 110) selects the third media content segment instead of the second media content segment for presentation to the user U if the success probability associated with the third media content segment is greater than the success probability associated with the second media content segment

In other embodiments, the server (e.g., CDN 110) selects the second media content segment instead of the third media content segment for presentation to the user U if the success probability associated with the second media content segment is less than the success probability associated with the third media content segment. Alternatively, the server (e.g., CDN 110) selects the third media content segment instead of the second media content segment for presentation to the user U if the success probability associated with the third media content segment is less than the success probability associated with the second media content segment.

In still other embodiments, the server (e.g., CDN 110) selects the second media content segment instead of the third media content segment for presentation to the user U if the success probability associated with the second media content segment is greater than the success probability associated with the third media content segment and if the success probability associated with the second media content segment is less than or equal to a maximum success probability value, such as not more than about 99%, not more than about 98%, not more than about 97%, not more than about 96%, not more than about 95%, not more than about 94%, not more than about 93%, not more than about 92%, not more than about 91%, not more than about 90%, not more than about 89%, not more than about 88%, not more than about 87%, not more than about 86%, not more than about 85%, not more than about 84%, not more than about 83%, not more than about 82%, not more than about 81%, not more than about 80%, not more than about 79%, not more than about 78%, not more than about 77%, not more than about 76%, not more than about 75%, not more than about 74%, not more than about 73%, not more than about 72%, not more than about 71%, not more than about 70%, not more than about 69%, not more than about 68%, not more than about 67%, not more than about 66%, not more than about 65%, not more than about 64%, not more than about 63%, not more than about 62%, not more than about 61%, not more than about 60%, not more than about 59%, not more than about 58%, not more than about 57%, not more than about 56%, not more than about 55%, not more than about 54%, not more than about 53%, not more than about 52%, not more than about 51%, or not more than about 50%. Alternatively, the server (e.g., CDN 110) selects the third media content segment instead of the second media content segment for presentation to the user U if the success probability associated with the third media content segment is greater than the success probability associated with the second media content segment and if the success probability associated with the third media content segment is less than or equal to a maximum success probability value, such as not more than about 99%, not more than about 98%, not more than about 97%, not more than about 96%, not more than about 95%, not more than about 94%, not more than about 93%, not more than about 92%, not more than about 91%, not more than about 90%, not more than about 89%, not more than about 88%, not more than about 87%, not more than about 86%, not more than about 85%, not more than about 84%, not more than about 83%, not more than about 82%, not more than about 81%, not more than about 80%, not more than about 79%, not more than about 78%, not more than about 77%, not more than about 76%, not more than about 75%, not more than about 74%, not more than about 73%, not more than about 72%, not more than about 71%, not more than about 70%, not more than about 69%, not more than about 68%, not more than about 67%, not more than about 66%, not more than about 65%, not more than about 64%, not more than about 63%, not more than about 62%, not more than about 61%, not more than about 60%, not more than about 59%, not more than about 58%, not more than about 57%, not more than about 56%, not more than about 55%, not more than about 54%, not more than about 53%, not more than about 52%, not more than about 51%, or not more than about 50%.

In still other embodiments, the server (e.g., CDN 110) selects the second media content segment instead of the third media content segment for presentation to the user U if the success probability associated with the second media content segment is less than the success probability associated with the third media content segment and if the success probability associated with the second media content segment is greater than or equal to a minimum success probability value, such as at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%), at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%. Alternatively, the server (e.g., CDN 110) selects the third media content segment instead of the second media content segment for presentation to the user U if the success probability associated with the third media content segment is less than the success probability associated with the second media content segment and if the success probability associated with the third media content segment is greater than or equal to a minimum success probability value, such as at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%.

In some embodiments of this method 500B, the mastery-indicating input(s) comprises an individual real-time mastery factor. Generally, the individual real-time mastery factor is associated with the user U's mastery of the first subject matter. For example, a component of (or the entire) individual real-time mastery factor may be the length of time between presentation of an interactive assessment (e.g., a prompt) to the user U (e.g., via media player 210) and receipt of a user mastery-indicating input (e.g., by the input capture device 220) that corresponds to a response (e.g., an attempted response or a correct response). The mastery-indicating input need not be a correct response to the interactive assessment; in some embodiments the time between presentation of the interactive assessment (e.g., the prompt) and any attempted mastery-indicating input by the user U provides useful information relevant to the user U's real-time mastery of the presented subject matter. In another non-limiting example, a component of (or the entire) individual real-time mastery factor may be the number of user mastery-indicating inputs (e.g., received by the input capture device 220) that correspond to incorrect responses before a user U's mastery-indicating input corresponding to a correct response is received by the input capture device 220. In yet another non-limiting example, a component of (or the entire) individual real-time mastery factor may be the fraction of a user U's mastery-indicating input (e.g., spoken input or text input received by the input capture device 220) that corresponds to a comparative response (e.g., a correct response or a series of expected responses). In still another non-limiting example, a component of (or the entire) individual real-time mastery factor may be the receipt (e.g., by the input capture device 220) of a mastery-indicating input that includes an audio input that corresponds to a sound or spoken expression associated with human uncertainty. Generally, receipt (e.g., by the input capture device 220) of a relatively high number of sounds or spoken expressions that are associated with human uncertainty indicate that the user U has not mastered the presented subject matter, while receipt of a relatively low number of sounds or spoken expressions that are associated with human uncertainty indicate that the user U has mastered the presented subject matter. In some embodiments the user U's baseline level of sounds and/or spoken expressions associated with human uncertainty (e.g., a frequency of such words uttered during the user U's normal speech) may be determined, and the frequency of sounds and spoken expressions associated with human uncertainty in response to an interactive assessment (e.g., a prompt) may be compared to the user U's baseline frequency level to determine (at least in part) the individual real-time mastery factor. Sounds or spoken expressions associated with human uncertainty vary from language to language; non-limiting examples include words or sounds that indicate speech disfluency such as (in English) “um,” “uh,” “erm,” and the like. In still another non-limiting example, a component of (or the entire) individual real-time mastery factor may be the receipt (e.g., by the input capture device 220) of a mastery-indicating input including an audio input corresponding to a sound or spoken expression associated with human certainty. Generally, receipt (e.g., by the input capture device 220) of a relatively high number of sounds or spoken expressions that are associated with human certainty indicate that the user U has mastered the presented subject matter, while receipt of a relatively low number of sounds or spoken expressions that are associated with human certainty indicate that the user U has not mastered the presented subject matter. In some embodiments the user U's baseline level of sounds and/or spoken expressions associated with human certainty (e.g., a frequency of such words uttered during the user U's normal speech) may be determined, and the frequency of sounds and spoken expressions associated with human certainty in response to an interactive assessment (e.g., a prompt) may be compared to the user U's baseline frequency level to determine (at least in part) the individual real-time mastery factor. Sounds or spoken expressions associated with human certainty vary from language to language; non-limiting examples include words or sounds such as (in English) “oh!” “I know that,” “aha!,” “yes,” and the like. In still another non-limiting example, a component of (or the entire) individual real-time mastery factor may be the receipt (e.g., by the input capture device 220) of a mastery-indicating input (e.g., a fraction of an image) that includes a facial expression or physical motion associated with human uncertainty. Generally, receipt or capture (e.g., by the input capture device 220) of a relatively high number of images or motions associated with human uncertainty indicate that the user U has not mastered the presented subject matter, while receipt or capture of a relatively low number of images or motions associated with human uncertainty indicate that the user U has mastered the presented subject matter. In some embodiments the user U's baseline level of facial expressions and motions associated with human uncertainty (e.g., a frequency of such expressions and motions emitted during normal speech) may be determined, and the frequency of expressions and motions associated with human uncertainty in response to an interactive assessment (e.g., a prompt) may be compared to the user U's baseline frequency level to determine (at least in part) the individual real-time mastery factor. Expressions and motions associated with human uncertainty vary from culture to culture; non-limiting examples in Western culture include a furrowed brow, a frown, a cringe, one or more hands contacting the forehead, one or more fingers running through one's hair, one's chin lowered to touch or nearly touch one's chest, and the like. In still another non-limiting example, a component of (or the entire) individual real-time mastery factor may be the receipt (e.g., by the input capture device 220) of a mastery-indicating input (e.g., a fraction of an image) including a facial expression or physical motion associated with human certainty. Generally, receipt or capture (e.g., by the input capture device 220) of a relatively high number of images or motions associated with human certainty indicate that the user U has mastered the presented subject matter, while receipt or capture of a relatively low number of images or motions associated with human certainty indicate that the user U has not mastered the presented subject matter. In some embodiments the user U's baseline level of facial expressions and motions associated with human certainty (e.g., a frequency of such expressions and motions emitted during normal speech) may be determined, and the frequency of expressions and motions associated with human certainty in response to an interactive assessment (e.g., a prompt) may be compared to the user U's baseline frequency level to determine (at least in part) the individual real-time mastery factor. Expressions and motions associated with human certainty vary from culture to culture; non-limiting examples in Western culture include a smile, a nod of the head, arms raised above the head, relaxed shoulder profile, and the like.

In some embodiments of this method 500B, the mastery-indicating input(s) comprises an individual cumulative mastery factor. The individual cumulative mastery factor, in some embodiments, includes a cumulative individual real-time mastery probability based on all of the user U's previous individual real-time mastery factors. In other embodiments, the individual cumulative mastery factor includes a cumulative individual real-time mastery probability that is calculated based on any one individual real-time mastery factor, or on any two or more individual real-time mastery factors. In still other embodiments, the individual cumulative mastery factor includes a cumulative learning exposure frequency that is calculated based on a number of times the user U has been presented the first subject matter. In still other embodiments, the individual cumulative mastery factor includes a cumulative learning exposure duration based on a length of time the user U has been presented the first subject matter. In still other embodiments, the individual cumulative mastery factor includes a length of time since the user U was last presented the first subject matter. In still other embodiments, the individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In still other embodiments, the individual cumulative mastery factor includes a cumulative individual real-time mastery probability that is calculated based on any one individual real-time mastery factor occurring within a predetermined time, such as within the past day, within the past week, within the past two weeks, within the past month, or within the past two months. In still other embodiments, the individual cumulative mastery factor includes a cumulative individual real-time mastery probability that is calculated based on any two or more individual real-time mastery factors occurring within a predetermined time, such as within the past day, within the past week, within the past two weeks, within the past month, or within the past two months. In still other embodiments, the individual cumulative mastery factor includes a cumulative learning exposure frequency based on a number of times the user U has been presented the first subject matter within a predetermined time, such as within the past day, within the past week, within the past two weeks, within the past month, or within the past two months. In some embodiments, the individual cumulative mastery factor includes any two or more of the foregoing, or all of the foregoing.

Referring now specifically to FIG. 2C, a computer-implemented method 500C of teaching a subject to a user U comprises providing, in step 510, by a server (e.g., CDN 110), media content 120 to a computing device associated with the user U. The media content 120 in some embodiments comprises a plurality of non-linear media content segments 122. The method 500C further comprises presenting, in step 520, a first media content segment to the user U via a computer-based media player 210. The first media content segment includes a first subject matter. The method 500C further comprises receiving, in step 522, demographic information associated with the user U. The demographic information may include any one or more of: the user U's nationality, the user U's native language, the user U's gender, the user U's occupation, the user U's age, and the user U's country of residence. The demographic information may be provided by the user U, for example as part of a registration process that occurs before step 510 is performed, via providing demographic information in the user U's profile, or via the input capture device 220 in response to an interactive assessment (e.g., a prompt) provided to the user U during or after presentation of a media content segment via media player 210. For example, in some embodiments, the demographic information includes user preferences received in the form of a mastery-indicating input by the user U to an interactive assessment (e.g., a prompt) such as “Would you like some tea, or would you prefer some coffee instead?” The mastery-indicating input provided by the user U to that interactive assessment (e.g., the prompt) via the input capture device 220 may be stored as a user preference type of demographic information associated with the user U. The method 500C further comprises receiving, in step 530, by an input capture device 220 associated with the user U, at least one mastery-indicating input from the user U during or after the step of presenting the first media content segment. The method 500C further comprises assessing, in step 540, a level of user mastery of the first subject matter based on the at least one mastery-indicating input.

In this method 500C, the step 550 of presenting the second media content segment to the user U or presenting, in step 560, the third media content segment to the user U is determined by the system 100 (e.g., by CDN 110) based at least in part on (a) the demographic information associated with the user obtained in step 522, and (b) the level of user mastery of the first subject matter assessed in step 540. The second media content segment includes a second subject matter; and the third media content segment includes a third subject matter that is different from the second subject matter.

For example and without limitation, the relevant demographic information may be the user U's gender. The system 100 may select the second media content segment, having a second subject matter reflecting male-specific grammatical patterns, to be presented to the user U (i.e., step 550 instead of step 560) if the user U demonstrates a relatively high level of mastery of the first subject matter (step 540) and the user's gender is male, instead of selecting the third media content segment, having a third subject matter reflecting female-specific grammatical patterns. In this example, the system 100 may select the third media content segment to be presented to the user U (i.e., step 560 instead of step 550) if the user's gender is female. Gender-specific grammatical patterns vary from language to language; non-limiting examples in romance languages may include different word endings for nouns and adjectives; different articles and different pronouns. In still another non-limiting example, the relevant demographic information may be the user U's age. The system 100 may select the second media content segment, having a second subject matter containing content relevant to a user with an age below a designated threshold, to be presented to the user U (i.e., step 550 instead of step 560) if the user U demonstrates a relatively high level of mastery of the first subject matter (step 540) and the user U's age is below the designated threshold, instead of selecting the third media content segment, having a third subject matter containing content relevant to a user U with an age above the designated threshold. In this example, the system 100 may select the third media content segment to be presented to the user U (i.e., step 560 instead of step 550) if the user's age is above the designated threshold. Content where relevance varies based on a user's age being above or below a designated threshold varies from culture to culture; non-limiting examples of content that is age-dependent includes content pertaining to driving a vehicle or content pertaining to drinking an alcoholic beverage.

In some embodiments of this method 500C, the step 510 of providing media content comprises transmitting the media content from the server (e.g., from CDN 110) to a storage component associated locally with the computer-based media player 210. In such embodiments, the step 520 of presenting the first media content segment to the user U comprises causing the computer-based media player 210 to retrieve the first media content segment from the local storage component. In such embodiments, the system 100 is enabled to present media content segments to the user U via media player 210 even if the media player 210 cannot communicate with the server (e.g., CDN 110), for example if the computing device is unable to connect to the server via wireless protocol.

In other embodiments of this method 500C, the step 520 of presenting the first media content segment to the user U comprises causing the computer-based media player 210 to retrieve the first media content segment from the server (e.g., from CDN 110). In such embodiments, the system 100 is enabled to cause the media player 210 to present any media content segment to the user U so long as the media content player 210 can communicate with the server (e.g., CDN 110).

In some embodiments of this method 500C, the second subject matter is different from the first subject matter, and the third subject matter is different from the first subject matter.

In some embodiments of this method 500C, one of the second subject matter and the third subject matter is the same as the first subject matter.

In some embodiments of this method 500C, the second media content segment and the third media content segment are selected from a plurality of media content segments based at least in part on the level of user mastery of the first subject matter and the user U's demographic information obtained in step 522.

In some embodiments of this method 500C, the mastery-indicating input(s) comprises an individual real-time mastery factor. Generally, the individual real-time mastery factor is associated with the user U's mastery of the first subject matter. For example, a component of (or the entire) individual real-time mastery factor may be the length of time between presentation of an interactive assessment (e.g., a prompt) to the user U (e.g., via media player 210) and receipt of a user mastery-indicating input (e.g., by the input capture device 220) that corresponds to a response (e.g., an attempted response or a correct response). The mastery-indicating input need not be a correct response to the interactive assessment; in some embodiments the time between presentation of the interactive assessment (e.g., the prompt) and any attempted answer by the user U provides useful information relevant to the user U's real-time mastery of the presented subject matter. In another non-limiting example, a component of (or the entire) individual real-time mastery factor may be the number of user mastery-indicating inputs (e.g., received by the input capture device 220) that correspond to incorrect responses before a user mastery-indicating input corresponding to a correct response is received by the input capture device 220. In yet another non-limiting example, a component of (or the entire) individual real-time mastery factor may be the fraction of a user mastery-indicating input (e.g., spoken input or text input received by the input capture device 220) that corresponds to a comparative response (e.g., a correct response or a series of expected responses). In still another non-limiting example, a component of (or the entire) individual real-time mastery factor may be the receipt (e.g., by the input capture device 220) of a mastery-indicating input that includes an audio input that corresponds to a sound or spoken expression associated with human uncertainty. Generally, receipt (e.g., by the input capture device 220) of a relatively high number of sounds or spoken expressions that are associated with human uncertainty indicate that the user U has not mastered the presented subject matter, while receipt of a relatively low number of sounds or spoken expressions that are associated with human uncertainty indicate that the user U has mastered the presented subject matter. In some embodiments the user U's baseline level of sounds and/or spoken expressions associated with human uncertainty (e.g., a frequency of such words uttered during the user U's normal speech) may be determined, and the frequency of sounds and spoken expressions associated with human uncertainty in response to an interactive assessment (e.g., a prompt) may be compared to the user U's baseline frequency level to determine (at least in part) the individual real-time mastery factor. Sounds or spoken expressions associated with human uncertainty vary from language to language; non-limiting examples include words or sounds that indicate speech disfluency such as (in English) “um,” “uh,” “erm,” and the like. In still another non-limiting example, a component of (or the entire) individual real-time mastery factor may be the receipt (e.g., by the input capture device 220) of a mastery-indicating input including an audio input corresponding to a sound or spoken expression associated with human certainty. Generally, receipt (e.g., by the input capture device 220) of a relatively high number of sounds or spoken expressions that are associated with human certainty indicate that the user U has mastered the presented subject matter, while receipt of a relatively low number of sounds or spoken expressions that are associated with human certainty indicate that the user U has not mastered the presented subject matter. In some embodiments the user U's baseline level of sounds and/or spoken expressions associated with human certainty (e.g., a frequency of such words uttered during the user U's normal speech) may be determined, and the frequency of sounds and spoken expressions associated with human certainty in response to an interactive assessment (e.g., a prompt) may be compared to the user U's baseline frequency level to determine (at least in part) the individual real-time mastery factor. Sounds or spoken expressions associated with human certainty vary from language to language; non-limiting examples include words or sounds such as (in English) “oh!” “I know that,” “aha!,” “yes,” and the like. In still another non-limiting example, a component of (or the entire) individual real-time mastery factor may be the receipt (e.g., by the input capture device 220) of a mastery-indicating input (e.g., a fraction of an image) that includes a facial expression or physical motion associated with human uncertainty. Generally, receipt or capture (e.g., by the input capture device 220) of a relatively high number of images or motions associated with human uncertainty indicate that the user U has not mastered the presented subject matter, while receipt or capture of a relatively low number of images or motions associated with human uncertainty indicate that the user U has mastered the presented subject matter. In some embodiments the user U's baseline level of facial expressions and motions associated with human uncertainty (e.g., a frequency of such expressions and motions emitted during normal speech) may be determined, and the frequency of expressions and motions associated with human uncertainty in response to an interactive assessment (e.g., a prompt) may be compared to the user U's baseline frequency level to determine (at least in part) the individual real-time mastery factor. Expressions and motions associated with human uncertainty vary from culture to culture; non-limiting examples in Western culture include a furrowed brow, a frown, a cringe, one or more hands contacting the forehead, one or more fingers running through one's hair, one's chin lowered to touch or nearly touch one's chest, and the like. In still another non-limiting example, a component of (or the entire) individual real-time mastery factor may be the receipt (e.g., by the input capture device 220) of a mastery-indicating input (e.g., a fraction of an image) including a facial expression or physical motion associated with human certainty. Generally, receipt or capture (e.g., by the input capture device 220) of a relatively high number of images or motions associated with human certainty indicate that the user U has mastered the presented subject matter, while receipt or capture of a relatively low number of images or motions associated with human certainty indicate that the user U has not mastered the presented subject matter. In some embodiments the user U's baseline level of facial expressions and motions associated with human certainty (e.g., a frequency of such expressions and motions emitted during normal speech) may be determined, and the frequency of expressions and motions associated with human certainty in response to an interactive assessment (e.g., a prompt) may be compared to the user U's baseline frequency level to determine (at least in part) the individual real-time mastery factor. Expressions and motions associated with human certainty vary from culture to culture; non-limiting examples in Western culture include a smile, a nod of the head, arms raised above the head, relaxed shoulder profile, and the like.

In some embodiments of this method 500C, the mastery-indicating input(s) comprises an individual cumulative mastery factor. The individual cumulative mastery factor, in some embodiments, includes a cumulative individual real-time mastery probability based on all of the user U's previous individual real-time mastery factors. In other embodiments, the individual cumulative mastery factor includes a cumulative individual real-time mastery probability that is calculated based on any one individual real-time mastery factor, or on any two or more individual real-time mastery factors. In still other embodiments, the individual cumulative mastery factor includes a cumulative learning exposure frequency that is calculated based on a number of times the user U has been presented the first subject matter. In still other embodiments, the individual cumulative mastery factor includes a cumulative learning exposure duration based on a length of time the user U has been presented the first subject matter. In still other embodiments, the individual cumulative mastery factor includes a length of time since the user U was last presented the first subject matter. In still other embodiments, the individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In still other embodiments, the individual cumulative mastery factor includes a cumulative individual real-time mastery probability that is calculated based on any one individual real-time mastery factor occurring within a predetermined time, such as within the past day, within the past week, within the past two weeks, within the past month, or within the past two months. In still other embodiments, the individual cumulative mastery factor includes a cumulative individual real-time mastery probability that is calculated based on any two or more individual real-time mastery factors occurring within a predetermined time, such as within the past day, within the past week, within the past two weeks, within the past month, or within the past two months. In still other embodiments, the individual cumulative mastery factor includes a cumulative learning exposure frequency based on a number of times the user U has been presented the first subject matter within a predetermined time, such as within the past day, within the past week, within the past two weeks, within the past month, or within the past two months. In some embodiments, the individual cumulative mastery factor includes any two or more of the foregoing, or all of the foregoing, or a measure of the level of change in demonstrated mastery of the first subject matter over time.

Referring now specifically to FIG. 2D, a computer-implemented method 500D of teaching a subject to a user U comprises a step 510 of providing, by a server (e.g., CDN 110), media content 120 to a computing device associated with the user U. The media content 120 in some embodiments comprises a plurality of non-linear media content segments 122. The method 500D further comprises presenting, in step 520, a first media content segment to the user U via a computer-based media player 210. The first media content segment includes a first subject matter. The method 500D further comprises receiving, in step 522, demographic information associated with the user U. The method 500D further comprises receiving, in step 530, by an input capture device 220 associated with the user U, at least one mastery-indicating input from the user U during or after the step of presenting the first media content segment. The method 500D further comprises assessing, in step 540, a level of user mastery of the first subject matter based on the at least one mastery-indicating input. These steps 510, 520, 530, and 540 operate in substantially the same way in this method 500D as described above with respect to method 500B shown representatively in FIG. 2B. The second subject matter is different from the third subject matter in this method 500D.

In some embodiments of this method 500D, the second subject matter is different from the first subject matter, and the third subject matter is different from the first subject matter.

In some embodiments of this method 500D, one of the second subject matter and the third subject matter is the same as the first subject matter.

Referring specifically to step 522, the demographic information may be provided by the user U, for example as part of a registration process that occurs before step 510 is performed, via providing demographic information in the user U's profile or via the input capture device 220 in response to an interactive assessment (e.g., a prompt) provided to the user U during or after presentation of a media content segment via media player 210.

For example and without limitation, the relevant demographic information may be the user U's gender. The system 100 may select the second media content segment, having a second subject matter reflecting male-specific grammatical patterns, to be presented to the user U (i.e., step 550 instead of step 560) if the user U demonstrates a relatively high level of mastery of the first subject matter (step 540) and the user's gender is male, instead of selecting the third media content segment, having a third subject matter reflecting female-specific grammatical patterns. In this example, the system 100 may select the third media content segment to be presented to the user U (i.e., step 560 instead of step 550) if the user's gender is female. Gender-specific grammatical patterns vary from language to language; non-limiting examples in romance languages may include different word endings for nouns and adjectives; different articles and different pronouns. In still another non-limiting example, the relevant demographic information may be the user U's age. The system 100 may select the second media content segment, having a second subject matter containing content relevant to a user with an age below a designated threshold, to be presented to the user U (i.e., step 550 instead of step 560) if the user U demonstrates a relatively high level of mastery of the first subject matter (step 540) and the user U's age is below the designated threshold, instead of selecting the third media content segment, having a third subject matter containing content relevant to a user U with an age above the designated threshold. In this example, the system 100 may select the third media content segment to be presented to the user U (i.e., step 560 instead of step 550) if the user's age is above the designated threshold. Content where relevance varies based on a user's age being above or below a designated threshold varies from culture to culture; non-limiting examples of content that is age-dependent includes content pertaining to driving a vehicle or content pertaining to drinking an alcoholic beverage.

In some embodiments, the step 540 of assessing a level of user mastery in computer-implemented method 500C or 500D is further based on the demographic information associated with the user obtained in step 522. For example, if the user demographic information reveals that the user U is female, the step 540 of assessing the level of user mastery of the first subject matter may include determining whether the mastery-indicating input captured by the input capture device 220 is associated with a first-person verbal response that is properly conjugated to match the user U's gender demographic information.

The method 500D further comprises determining, in step 542, a second success probability associated with the user U for a second media content segment including a second subject matter, and a third success probability associated with the user U for a third media content segment including a third subject matter.

In some embodiments, the step 542 of determining the success probability associated with the user for the second media content segment comprises determining an individual success probability factor associated with the user U for subject matter of the second media content segment (i.e., the second subject matter), and determining an individual success probability factor associated with the user U for subject matter of the third media content segment (i.e., the third subject matter).

In some embodiments, the individual success probability factor associated with the user for the subject matter of the second media content segment comprises a second individual cumulative mastery factor, and the individual success probability factor associated with the user for the subject matter of the third media content segment comprises a third individual cumulative mastery factor. The second or third individual cumulative mastery factor, in some embodiments, includes a cumulative individual real-time mastery probability based on all of the user U's previous individual real-time mastery factors associated with the second subject matter or the third subject matter, respectively. In some embodiments, the second or third individual cumulative mastery factor includes a cumulative individual real-time mastery probability based on any one individual real-time mastery factor, or on any two or more individual real-time mastery factors. In some embodiments, the second or third individual cumulative mastery factor includes a length of time since the user U was last presented the second subject matter or the third subject matter, respectively. In some embodiments, the second or third individual cumulative mastery factor includes a cumulative learning exposure frequency based on a number of times the user U has been presented the second subject matter or the third subject matter, respectively. In some embodiments, the second or third individual cumulative mastery factor includes a cumulative learning exposure duration based on a length of time the user U has been presented the second subject matter or the third subject matter, respectively. In some embodiments, the second or third individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In some embodiments, the second or third individual cumulative mastery factor includes a cumulative individual real-time mastery probability based on any one individual real-time mastery factor occurring within a predetermined time, such as within the past day, within the past week, within the past two weeks, within the past month, or within the past two months. In some embodiments, the second or third individual cumulative mastery factor includes a cumulative individual real-time mastery probability based on any two or more individual real-time mastery factors occurring within a predetermined time, such as within the past day, within the past week, within the past two weeks, within the past month, or within the past two months. In some embodiments, the second or third individual cumulative mastery factor includes a cumulative learning exposure frequency based on a number of times the user U has been presented the second subject matter or the third subject matter, respectively, within a predetermined time, such as within the past day, within the past week, within the past two weeks, within the past month, or within the past two months. In some embodiments, the second or third individual cumulative mastery factor includes an improvement factor based on the level of change in the user U's demonstrated mastery of the second subject matter or the third subject matter, respectively. In some embodiments, the second or third individual cumulative mastery factor includes any two or more of the foregoing, or all of the foregoing.

In some embodiments of this method 500D, the individual success probability factor associated with the user U for subject matter of the second media content segment or the third media content segment comprises a cumulative individual mastery value based on all of the user U's previous individual real-time mastery factors associated with the subject matter of the second media content segment or the third media content segment, respectively. In some embodiments, the individual success probability factor associated with the user U for subject matter of the second media content segment or the third media content segment comprises a cumulative individual mastery value based on any one individual real-time mastery factor or on any two or more individual real-time mastery factors. In some embodiments, the individual success probability factor associated with the user U for subject matter of the second media content segment or the third media content segment comprises a cumulative learning exposure frequency based on a number of times the user U has been presented the second subject matter or the third subject matter, respectively. In some embodiments, the individual success probability factor associated with the user U for subject matter of the second media content segment or the third media content segment comprises a cumulative individual real-time mastery value based on the user U's previous individual real-time mastery factors occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative individual mastery value based on any one individual real-time mastery factor occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative individual mastery value based on any two or more individual real-time mastery factors occurring within a predetermined time, such as within the past day, within the past week, within the past two weeks, within the past month, or within the past two months. In some embodiments, the individual success probability factor associated with the user U for subject matter of the second media content segment or the third media content segment comprises a cumulative learning exposure frequency based on a number of times the user U has been presented the second subject matter or the third subject matter within a predetermined time, such as within the past day, within the past week, within the past two weeks, within the past month, or within the past two months. In some embodiments, the individual success probability factor associated with the user U for subject matter of the second media content segment or the third media content segment includes any two or more of the foregoing, or all of the foregoing.

In some embodiments of this method 500D, the step 542 of determining the success probability associated with the user U for the second media content segment or the third media content segment comprises determining a collective success probability factor for the user U associated with subject matter of the second media content segment or the third media content segment, respectively. In general, the collective success probability factor associated with the subject matter of the second media content segment (i.e., the second subject matter) reflects a probability that the user U will master the second subject matter (e.g., the user U will provide one or more mastery-indicating inputs via input capture device 220 that demonstrate the user U's mastery of the second subject matter) after the second subject matter is presented to the user U (e.g., via media player 210) the first time. Similarly, the collective success probability factor associated with the subject matter of the third media content segment (i.e., the third subject matter) reflects a probability that the user U will master the third subject matter (e.g., the user U will provide one or more mastery-indicating inputs via input capture device 220 that demonstrate the user U's mastery of the third subject matter) after the third subject matter is presented to the user U (e.g., via media player 210) the first time.

In some embodiments of this method 500D, the collective success probability factor for the user U associated with the subject matter of the second media content segment or the third media content segment is based at least in part on a difficulty factor associated with the second subject matter or the third subject matter, respectively. In some embodiments, the difficulty factor is an initial difficulty factor based at least in part on a number of syllables of the second subject matter or the third subject matter, respectively. In some embodiments, the difficulty factor is an initial difficulty factor based at least in part on a number of letters of the second subject matter or the third subject matter, respectively. n some embodiments, the difficulty factor is an initial difficulty factor based at least in part on a frequency of usage of the second subject matter or the third subject matter, respectively, in common usage. In some embodiments, the difficulty factor is an initial difficulty factor based on any two or more of the foregoing, or all of the foregoing.

In some embodiments of this method 500D, the difficulty factor is a cumulative difficulty factor based at least in part on a mastery success rate associated with a plurality of other users exposed to the second subject matter or the third subject matter, respectively.

The method 500D further comprises, in step 550, of presenting the second media content segment to the user U or, in step 560, presenting the third media content segment to the user U based at least in part on the demographic information associated with the user U from step 522, the level of user mastery of the first subject matter (step 540), the success probability associated with the user for the second media content segment (step 542), and the success probability associated with the user for the third media content segment (step 542).

In some embodiments of this method 500D, the second media content segment and the third media content segment are selected from a plurality of media content segments based at least in part on the level of user mastery of the first subject matter, the success probability associated with the user for the second subject matter, the success probability associated with the user for the third subject matter, the success probability associated with the user for each of the plurality of subject matters, and/or the demographic information associated with the user.

In some embodiments, the server (e.g., CDN 110) selects the second media content segment instead of the third media content segment for presentation to the user U if the success probability associated with the second media content segment is greater than the success probability associated with the third media content segment. Alternatively, the server (e.g., CDN 110) selects the third media content segment instead of the second media content segment for presentation to the user U if the success probability associated with the third media content segment is greater than the success probability associated with the second media content segment.

In other embodiments, the server (e.g., CDN 110) selects the second media content segment instead of the third media content segment for presentation to the user U if the success probability associated with the second media content segment is less than the success probability associated with the third media content segment. Alternatively, the server (e.g., CDN 110) selects the third media content segment instead of the second media content segment for presentation to the user U if the success probability associated with the third media content segment is less than the success probability associated with the second media content segment.

In still other embodiments, the server (e.g., CDN 110) selects the second media content segment instead of the third media content segment for presentation to the user U if the success probability associated with the second media content segment is greater than the success probability associated with the third media content segment and if the success probability associated with the second media content segment is less than or equal to a maximum success probability value, such as not more than about 99%, not more than about 98%, not more than about 97%, not more than about 96%, not more than about 95%, not more than about 94%, not more than about 93%, not more than about 92%, not more than about 91%, not more than about 90%, not more than about 89%, not more than about 88%, not more than about 87%, not more than about 86%, not more than about 85%, not more than about 84%, not more than about 83%, not more than about 82%, not more than about 81%, not more than about 80%, not more than about 79%, not more than about 78%, not more than about 77%, not more than about 76%, not more than about 75%, not more than about 74%, not more than about 73%, not more than about 72%, not more than about 71%, not more than about 70%, not more than about 69%, not more than about 68%, not more than about 67%, not more than about 66%, not more than about 65%, not more than about 64%, not more than about 63%, not more than about 62%, not more than about 61%, not more than about 60%, not more than about 59%, not more than about 58%, not more than about 57%, not more than about 56%, not more than about 55%, not more than about 54%, not more than about 53%, not more than about 52%, not more than about 51%, or not more than about 50%. Alternatively, the server (e.g., CDN 110) selects the third media content segment instead of the second media content segment for presentation to the user U if the success probability associated with the third media content segment is greater than the success probability associated with the second media content segment and if the success probability associated with the third media content segment is less than or equal to a maximum success probability value, such as not more than about 99%, not more than about 98%, not more than about 97%, not more than about 96%, not more than about 95%, not more than about 94%, not more than about 93%, not more than about 92%, not more than about 91%, not more than about 90%, not more than about 89%, not more than about 88%, not more than about 87%, not more than about 86%, not more than about 85%, not more than about 84%, not more than about 83%, not more than about 82%, not more than about 81%, not more than about 80%, not more than about 79%, not more than about 78%, not more than about 77%, not more than about 76%, not more than about 75%, not more than about 74%, not more than about 73%, not more than about 72%, not more than about 71%, not more than about 70%, not more than about 69%, not more than about 68%, not more than about 67%, not more than about 66%, not more than about 65%, not more than about 64%, not more than about 63%, not more than about 62%, not more than about 61%, not more than about 60%, not more than about 59%, not more than about 58%, not more than about 57%, not more than about 56%, not more than about 55%, not more than about 54%, not more than about 53%, not more than about 52%, not more than about 51%, or not more than about 50%.

In still other embodiments, the server (e.g., CDN 110) selects the second media content segment instead of the third media content segment for presentation to the user U if the success probability associated with the second media content segment is less than the success probability associated with the third media content segment and if the success probability associated with the second media content segment is greater than or equal to a minimum success probability value, such as at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%), at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%. Alternatively, the server (e.g., CDN 110) selects the third media content segment instead of the second media content segment for presentation to the user U if the success probability associated with the third media content segment is less than the success probability associated with the second media content segment and if the success probability associated with the third media content segment is greater than or equal to a minimum success probability value, such as at least about 50%, at least about 51%, at least about 52%, at least about 53%, at least about 54%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70%, at least about 71%, at least about 72%, at least about 73%, at least about 74%, at least about 75%, at least about 76%, at least about 77%, at least about 78%, at least about 79%, at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, or at least about 99%.

In some embodiments of this method 500D, the mastery-indicating input(s) comprises an individual real-time mastery factor. Generally, the individual real-time mastery factor is associated with the user U's mastery of the first subject matter. For example, a component of (or the entire) individual real-time mastery factor may be the length of time between presentation of an interactive assessment (e.g., a prompt) to the user U (e.g., via media player 210) and receipt of a user mastery-indicating input (e.g., by the input capture device 220) that corresponds to a response (e.g., an attempted response or a correct response). The mastery-indicating input need not be a correct response to the interactive assessment; in some embodiments the time between presentation of the interactive assessment (e.g., the prompt) and any attempted answer by the user U provides useful information relevant to the user U's real-time mastery of the presented subject matter. In another non-limiting example, a component of (or the entire) individual real-time mastery factor may be the number of user mastery-indicating inputs (e.g., received by the input capture device 220) that correspond to incorrect responses before a user mastery-indicating input corresponding to a correct response is received by the input capture device 220. In yet another non-limiting example, a component of (or the entire) individual real-time mastery factor may be the fraction of a user mastery-indicating input (e.g., spoken input or text input received by the input capture device 220) that corresponds to a comparative response (e.g., a correct response or a series of expected responses). In still another non-limiting example, a component of (or the entire) individual real-time mastery factor may be the receipt (e.g., by the input capture device 220) of a mastery-indicating input that includes an audio input that corresponds to a sound or spoken expression associated with human uncertainty. Generally, receipt (e.g., by the input capture device 220) of a relatively high number of sounds or spoken expressions that are associated with human uncertainty indicate that the user U has not mastered the presented subject matter, while receipt of a relatively low number of sounds or spoken expressions that are associated with human uncertainty indicate that the user U has mastered the presented subject matter. In some embodiments the user U's baseline level of sounds and/or spoken expressions associated with human uncertainty (e.g., a frequency of such words uttered during the user U's normal speech) may be determined, and the frequency of sounds and spoken expressions associated with human uncertainty in response to an interactive assessment (e.g., a prompt) may be compared to the user U's baseline frequency level to determine (at least in part) the individual real-time mastery factor. Sounds or spoken expressions associated with human uncertainty vary from language to language; non-limiting examples include words or sounds that indicate speech disfluency such as (in English) “um,” “uh,” “erm,” and the like. In still another non-limiting example, a component of (or the entire) individual real-time mastery factor may be the receipt (e.g., by the input capture device 220) of a mastery-indicating input including an audio input corresponding to a sound or spoken expression associated with human certainty. Generally, receipt (e.g., by the input capture device 220) of a relatively high number of sounds or spoken expressions that are associated with human certainty indicate that the user U has mastered the presented subject matter, while receipt of a relatively low number of sounds or spoken expressions that are associated with human certainty indicate that the user U has not mastered the presented subject matter. In some embodiments the user U's baseline level of sounds and/or spoken expressions associated with human certainty (e.g., a frequency of such words uttered during the user U's normal speech) may be determined, and the frequency of sounds and spoken expressions associated with human certainty in response to an interactive assessment (e.g., a prompt) may be compared to the user U's baseline frequency level to determine (at least in part) the individual real-time mastery factor. Sounds or spoken expressions associated with human certainty vary from language to language; non-limiting examples include words or sounds such as (in English) “oh!” “I know that,” “aha!,” “yes,” and the like. In still another non-limiting example, a component of (or the entire) individual real-time mastery factor may be the receipt (e.g., by the input capture device 220) of a mastery-indicating input (e.g., a fraction of an image) that includes a facial expression or physical motion associated with human uncertainty. Generally, receipt or capture (e.g., by the input capture device 220) of a relatively high number of images or motions associated with human uncertainty indicate that the user U has not mastered the presented subject matter, while receipt or capture of a relatively low number of images or motions associated with human uncertainty indicate that the user U has mastered the presented subject matter. In some embodiments the user U's baseline level of facial expressions and motions associated with human uncertainty (e.g., a frequency of such expressions and motions emitted during normal speech) may be determined, and the frequency of expressions and motions associated with human uncertainty in response to an interactive assessment (e.g., a prompt) may be compared to the user U's baseline frequency level to determine (at least in part) the individual real-time mastery factor. Expressions and motions associated with human uncertainty vary from culture to culture; non-limiting examples in Western culture include a furrowed brow, a frown, a cringe, one or more hands contacting the forehead, one or more fingers running through one's hair, one's chin lowered to touch or nearly touch one's chest, and the like. In still another non-limiting example, a component of (or the entire) individual real-time mastery factor may be the receipt (e.g., by the input capture device 220) of a mastery-indicating input (e.g., a fraction of an image) including a facial expression or physical motion associated with human certainty. Generally, receipt or capture (e.g., by the input capture device 220) of a relatively high number of images or motions associated with human certainty indicate that the user U has mastered the presented subject matter, while receipt or capture of a relatively low number of images or motions associated with human certainty indicate that the user U has not mastered the presented subject matter. In some embodiments the user U's baseline level of facial expressions and motions associated with human certainty (e.g., a frequency of such expressions and motions emitted during normal speech) may be determined, and the frequency of expressions and motions associated with human certainty in response to an interactive assessment (e.g., a prompt) may be compared to the user U's baseline frequency level to determine (at least in part) the individual real-time mastery factor. Expressions and motions associated with human certainty vary from culture to culture; non-limiting examples in Western culture include a smile, a nod of the head, arms raised above the head, relaxed shoulder profile, and the like.

In some embodiments of this method 500D, the mastery-indicating input(s) comprises an individual cumulative mastery factor. The individual cumulative mastery factor, in some embodiments, includes a cumulative individual real-time mastery probability based on all of the user U's previous individual real-time mastery factors. In other embodiments, the individual cumulative mastery factor includes a cumulative individual real-time mastery probability that is calculated based on any one individual real-time mastery factor, or on any two or more individual real-time mastery factors. In still other embodiments, the individual cumulative mastery factor includes a cumulative learning exposure frequency that is calculated based on a number of times the user U has been presented the first subject matter. In still other embodiments, the individual cumulative mastery factor includes a cumulative learning exposure duration based on a length of time the user U has been presented the first subject matter. In still other embodiments, the individual cumulative mastery factor includes a length of time since the user U was last presented the first subject matter. In still other embodiments, the individual cumulative mastery factor includes a cumulative individual real-time mastery probability based on the user U's previous individual real-time mastery factors occurring within a predetermined time, such as within the past day, within the past week, within the past two weeks, within the past month, or within the past two months. In still other embodiments, the individual cumulative mastery factor includes a cumulative individual real-time mastery probability that is calculated based on any one individual real-time mastery factor occurring within a predetermined time, such as within the past day, within the past week, within the past two weeks, within the past month, or within the past two months. In still other embodiments, the individual cumulative mastery factor includes a cumulative individual real-time mastery probability that is calculated based on any two or more individual real-time mastery factors occurring within a predetermined time, such as within the past day, within the past week, within the past two weeks, within the past month, or within the past two months. In still other embodiments, the individual cumulative mastery factor includes a cumulative learning exposure frequency based on a number of times the user U has been presented the first subject matter within a predetermined time, such as within the past day, within the past week, within the past two weeks, within the past month, or within the past two months. In some embodiments, the individual cumulative mastery factor includes any two or more of the foregoing, or all of the foregoing.

In some embodiments of computer-based methods 500A and/or 500B, the steps 550/560 of presenting the second media content segment or the third media content segment for presentation to the user U is based at least in part on demographic information associated with the user. The demographic information may be obtained, for example, through a user registration process before step 510 is performed in method 500A or 500B, via providing demographic information in the user U's profile, or via the input capture device 220 in response to an interactive assessment (e.g., a prompt) provided to the user during or after presentation of a media content segment via media player 210.

The methods 500A-500D of the present disclosure are suitable for teaching a variety of subjects to a user U. For example and without limitation, the subject matter corresponding to the media content 120 may be a language. In other embodiments, the subject matter corresponding to the media content 120 may be a citizenship test (e.g., for a naturalization process).

In any embodiment disclosed herein, the first media content segment, the second media content segment, and/or the third media content segment may be an advertisement. In some embodiments, the advertisement may be related to the first subject matter, the second subject matter, or the third subject matter. In some embodiments, the advertisement may include an interactive assessment (e.g., a prompt) to which the user U must respond, for example by demonstrating mastery of a subject matter associated with the subject matter of the media content 120; in such embodiments, the step 540 of assessing the level of user mastery may be based at least in part on the user U's response (e.g., a mastery-indicating input) to the interactive assessment (e.g., the prompt) in the advertisement. For example and without limitation, the advertisement may feature one or more characters using a phrase in the language being taught, such as “I want,” wherein the phrase is the first subject matter. The advertisement may depict, for example, two characters shopping in a market and discussing items that they each want to purchase, using the phrase “I want.” The interactive assessment (e.g., the prompt) associated with the advertisement may then ask the user U whether they want specific items from the market, and the user U may then respond with phrases in the language associated with the subject matter of the media content 120 like “Yes, I want a cola” and/or “Yes, I want this pasta” and/or “No, I do not want that pasta,” with those spoken responses captured by the input capture device 220. The input capture device 220 may then provide the user U's responses to the CDN 110 (along with any other captured mastery-indicating inputs) for determination, in step 540, of a level of user mastery over the first subject matter (i.e., the phrase “I want”). In this non-limiting example, the advertised items could include specific brands of cola and/or specific brands of pasta.

In any embodiment herein, the step 550 of presenting the second media content segment to the user U may optionally not include receiving a selection (e.g., of the second media content segment) from the user U. Similarly, the step 560 of presenting the third media content segment, in any embodiment herein, may optionally not include receiving a selection (e.g., of the third media content segment) from the user U.

In any embodiment herein, an interactive assessment (e.g., a prompt) to be presented to the user U (e.g., during or at the end of providing a media content segment 122 to the user U) may be selected from a plurality of available interactive assessments (e.g., available prompts) associated with the subject matter of the media content segment 122. In some such embodiments, for example, the interactive assessment (e.g., the prompt) may be selected based at least in part on the demographic information associated with the user U. For example and without limitation, if the available interactive assessments (e.g., available prompts) associated with the subject matter include “How do you take your coffee?” and “How do you take your tea?”, the interactive assessment (e.g., prompt) “How do you take your coffee?” may be selected and provided to the user U if the demographic information associated with the user U indicates that the user U prefers to drink coffee instead of tea.

In some embodiments, the interactive assessment (e.g., prompt) is selected from a plurality of interactive assessments (e.g., prompts) based at least in part on an individual cumulative mastery factor comprising one or more of: cumulative individual real-time mastery probability based on all of the user's previous individual real-time mastery factors, cumulative individual real-time mastery probability based on any one individual real-time mastery factor, cumulative individual real-time mastery probability based on any two or more individual real-time mastery factors, cumulative learning exposure frequency based on a number of times the user has been presented the relevant subject matter, cumulative learning exposure duration based on a length of time the user has been presented the relevant subject matter, a length of time since the user was last presented the relevant subject matter, cumulative individual real-time mastery probability based on the user's previous individual real-time mastery factors occurring within a predetermined time, cumulative individual real-time mastery probability based on any one individual real-time mastery factor occurring within a predetermined time, cumulative individual real-time mastery probability based on any two or more individual real-time mastery factors occurring within a predetermined time, cumulative learning exposure frequency based on a number of times the user has been presented the relevant subject matter within a predetermined time, and/or cumulative individual real-time mastery associated with all mastery-indicating inputs received by the input capture device.

In any embodiment herein, the subsequent media content segment 122 selected to be presented to the user U via the media player 210 may include user feedback. Such media content segments 122 may include feedback based at least in part on the mastery-indicating input captured by the input capture device 220 to the most recent interactive assessment (e.g., prompt). For example, the user feedback media content segment 122 may include audio and/or video media informing the user U that their most recently captured mastery-indicating input was “Perfect” if the confidence score is very high, “Very good” if the confidence score is relatively high, “Good” if the confidence score was about average, or “Let's try that again” if the confidence score is relatively low. In some embodiments, the user feedback media content segment 122 includes an interactive assessment (e.g., prompt) asking the user U to repeat the mastery-indicating input, for example if the confidence score is at or near zero, or if no mastery-indicating input was captured by the input capture device 220.

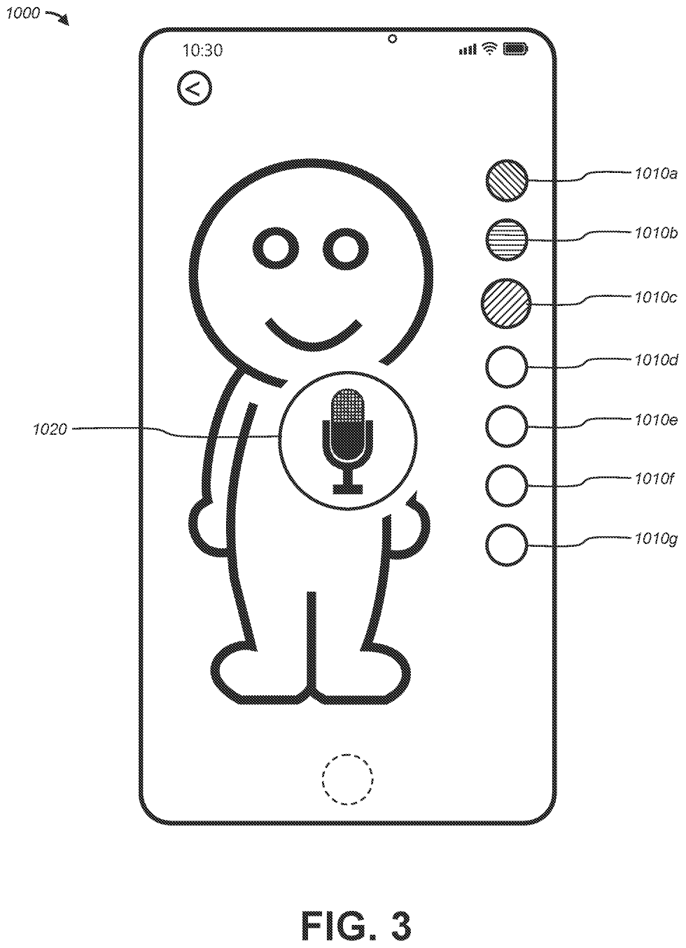

Referring now to FIG. 3, in some embodiments the present disclosure provides a user display 1000 for a learning module. The learning module comprises media content including one or more media content segments representing at least one subject matter. In the example specifically shown in FIG. 3, the media content includes at least seven subject matters: each of visual progress indicators 1010a through 1010g represents one subject matter that will be displayed to the user U during the learning module via media content 120 corresponding to each subject matter. Each visual progress indicator 1010a-g thus represents one or more non-linear media contents 120 each comprising a plurality of media content segments 122. For example, and consistent with other embodiments described herein and represented by FIGS. 1-2D, the user display 1000 here is displaying a third subject matter associated with at least one non-linear media content 120, as shown by the visually distinct media segment icon 1010c. If the user U demonstrates a relatively high level of mastery of the third subject matter, the display 1000 may display a fourth subject matter 1010d associated with its own non-linear media content 120. Or, if the user U does not demonstrate a relatively high level of mastery of the third subject matter 1010c, the display 1000 may instead display a non-linear media content 120 associated with a fifth subject matter 1010c′ and determine the user U's level of mastery of the fifth subject matter 1010c′ before displaying the non-linear media content 120 associated with the fourth subject matter 1010d.

The user display 1000 may in some embodiments display a subject matter indicator 1010a-1010g when the user U completes that media content segment by, for example, providing a response (e.g., a mastery-indicating input) to an interactive assessment (e.g., a prompt) provided via the user display 1000. The modified subject matter indicator may indicate a level of mastery associated with the user U's individual cumulative mastery related to that subject matter. For example, the modified subject matter indicator may indicate a high level of mastery by a first color or pattern (e.g., modified subject matter indicator 1010a), a moderate level of mastery by a second color or pattern (e.g., modified subject matter indicator 1010b), or a low level of mastery by a third color or pattern (e.g., modified subject matter indicator 1010c). In the example specifically shown in FIG. 3, the user U has not yet completed the fourth, fifth, sixth, or seventh subject matters (1010d-1010g) as indicated by a fourth color or pattern.

In some embodiments, a final media content segment 1010g is provided as an advanced subject matter. In some such embodiments, the display 1000 may only display the advanced subject matter 1010g to the user U if the user U demonstrates high level of mastery for all or substantially all of the other subject matters within the learning module (e.g., each of subject matters 1010a-1010f in the example specifically shown in FIG. 3).

In some embodiments, the user display 1000 displays a visible interactive assessment (e.g., prompt) indicator 1020 to inform the user U that an interactive assessment (e.g., a prompt) has been provided and the user U should provide a mastery-indicating input (e.g., a response), such as an audible response (e.g., speaking or singing a word, phrase, or utterance out loud) or gesture.

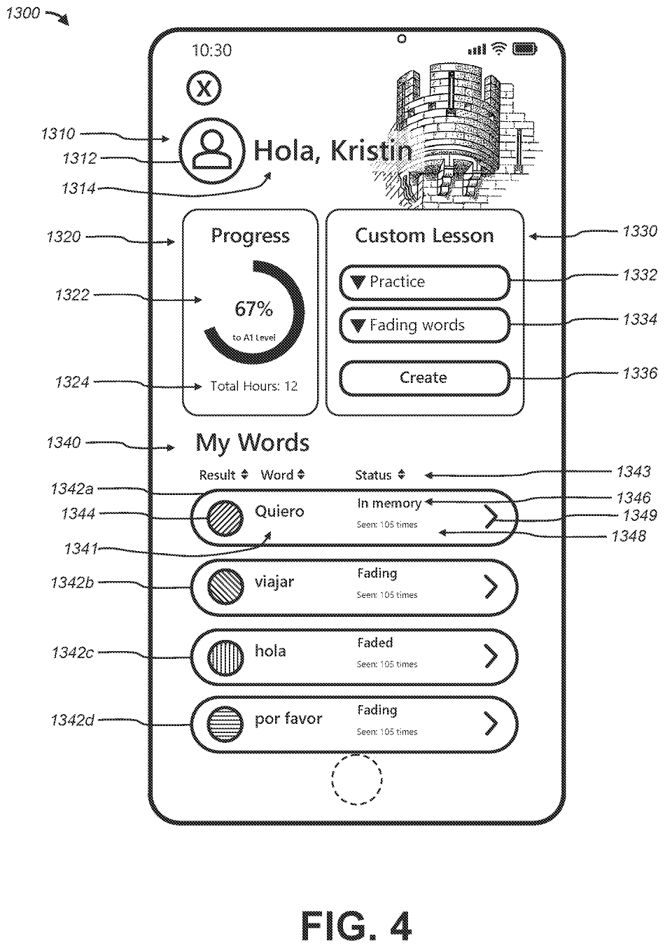

Referring now to FIG. 4, the present disclosure provides a user-specific display 1300 including a user identifier 1310 and a progress indicator 1320. The user identifier 1310 may include, for example, a profile picture or icon 1312, and the user U's name or username 1314, optionally in the form of a greeting associated with the subject matter of the media content. The progress indicator 1320 displays information about the user U's progress through the media content 120 or through the media content segments 122, for example through a progress graphic 1322. In some embodiments, the progress indicator 1320 further includes information about how much time the user U has engaged with the media content 120, for example through a total hours indicator 1324.

In some embodiments, the user-specific display 1300 further includes a custom lesson selector 1330 configured to enable the user U to create a media content 120 including a plurality of media content segments 122. In some embodiments, the custom lesson selector 1330 includes a lesson type selector 1332 configured to enable the user U to select a type of lesson format (e.g., an introduction lesson format, a vocabulary lesson format, a practice lesson format) for the custom lesson. In the embodiment specifically shown in FIG. 4, for example, the user U has selected a practice lesson format from a dropdown menu lesson type selector 1332. In some embodiments, the custom lesson selector 1330 further includes a subject matter status type selector 1334 configured to enable the user U to select a subject matter type for the custom lesson. In some embodiments, the subject matter type selector enables the user U to select subject matter types corresponding to subject matter that is “in memory,” subject matter that is “fading” out of memory, or subject matter that has already “faded” from memory, corresponding to subject matter that the user U would be expected to perform well, moderately well, and not well, respectively. In the example specifically shown in FIG. 4, the user U has selected subject matter that is “fading” from the user U's memory, that is, subject matter that the user U would be expected to perform relatively poorly compared to the user U's previous performances. The custom lesson selector 1330 may also include a create button 1336 that, when activated, creates the media content 120 based on the user U's selections of lesson type 1332 and subject matter status type 1334.

In some embodiments, the user-specific display 1300 further includes a user-specific subject matter sub-display 1340 configured to display information about the user U's performance on one or more subject matters 1341. In some embodiments, the user-specific subject matter sub-display 1340 displays a plurality of subject matter sub-displays 1342a-1342d, each associated with a unique subject matter 1341. Each user-specific subject matter sub-display 1342a-1342d may include a user mastery indicator 1344 that illustrates a current level of user mastery associated with the subject matter 1341 (e.g., an individual cumulative mastery associated with the corresponding subject matter 1341). In some embodiments, the user-specific subject matter sub-display 1340 includes a subject matter status indicator 1346 that illustrates the current status of the subject matter 1341 (e.g., in memory, fading, or faded, corresponding to subject matter associated with a high level of recent user mastery, a moderate level of recent user mastery, and a low level of recent user mastery, respectively). In some embodiments, the user-specific subject matter sub-display 1340 includes subject matter statistical information 1348 that displays, for example, how many times the user U has been exposed to the subject matter 1341, and/or how recently the user U was exposed to the subject matter 1341. In some embodiments, the user-specific subject matter sub-display 1340 includes one or more sort options 1343 configured to enable the user U to sort the subject matter sub-displays 1342a-1342d by one or more parameters, such as the user mastery indicator 1344, the subject matter 1341 (e.g., alphabetically), and/or the subject matter status indicator 1346. In some embodiments, the user-specific subject matter sub-display 1340 includes a selector button 1349 that, when activated, displays a subject matter-specific display associated with the subject matter 1341. In some embodiments, activating the selector button 1349 displays all the media content segments 122 that contain the selected subject matter and an option to navigate to one of those shown segments 122.

What is claimed is:

1. A computer-implemented method of teaching a subject to a user, the method comprising:
providing, by a server, non-linear media content to a computing device associated with the user, wherein the non-linear media content comprises a plurality of media content segments;
presenting a first media content segment to the user via a computer-based media player, wherein the first media content segment includes a first subject matter;
providing, by the computer-based media player, an interactive assessment (e.g., a prompt) to the user;
receiving, by an input capture device associated with the user, at least one mastery-indicating input from the user during or after the step of providing the interactive assessment (e.g., prompt) to the user;
assessing, based at least in part on the at least one mastery-indicating input, a level of user mastery of the first subject matter;
selecting a subsequent media content segment from the plurality of media content segments based at least in part on the level of user mastery; and
presenting the subsequent media content segment to the user via the computer-based media player,
wherein the mastery-indicating input comprises a word, phrase, sentence or utterance spoken by the user.

2. The computer-implemented method of claim 1, wherein the subsequent media content segment includes user feedback in response to the mastery-indicating input received by the input capture device.

3. The computer-implemented method of claim 1, wherein the subsequent media content segment includes a second interactive assessment that is different than the first interactive assessment.

4. The computer-implemented method of claim 1, wherein the subsequent media content segment includes user feedback in response to the mastery-indicating input, and wherein the computer-implemented method further comprises:
selecting a second subsequent media content segment including a second interactive assessment that is different from the first interactive assessment, from the plurality of media content segments based at least in part on the level of user mastery; and
presenting the second subsequent media content segment to the user via the computer-based media player after the step of presenting the subsequent media content segment to the user.

5. The computer-implemented method of claim 1, wherein the interactive assessment (e.g., prompt) invites the user to provide a spoken mastery-indicating input (e.g., a response).

6. The computer-implemented method of claim 5, wherein the interactive assessment (e.g., prompt) is selected from the group consisting of: an open-ended question; a dichotomous question (e.g., a yes/no question or an A/B choice question); a prompt to choose between two or more options; a rank order question; a Likert scale question; a semantic differential scale question; a demographic question; a request to translate a word, phrase or sentence from one language to another; a portion of a conversation requiring a response; a request to repeat a word, phrase or sentence spoken in the interactive assessment; and a prompt to provide a mastery-indicating input to a previous interactive assessment (e.g., a prompt asking the user to try again).

7. The computer-implemented method of claim 5, wherein the interactive assessment consists essentially of a statement that invites a mastery-indicating input but does not include an inquiry word or phrase.

8. The computer-implemented method of claim 1, wherein the step of providing media content comprises transmitting the media content from the server to a storage component associated locally with the computer-based media player; and wherein the step of presenting the first media content segment to the user comprises causing the computer-based media player to retrieve the first media content segment from the storage component.

9. The computer-implemented method of claim 1, wherein the step of presenting the first media content segment to the user comprises causing the computer-based media player to retrieve the first media content segment from the server.

10. The computer-implemented method of claim 1, wherein the at least one mastery-indicating input comprises an individual real-time mastery factor, wherein the individual real-time mastery factor is associated with the user's mastery of the first subject matter.

11. The computer-implemented method of claim 10, wherein the individual real-time mastery factor comprises one or more of: length of time between an interactive assessment (e.g., a prompt) and receipt of a user input corresponding to a response (e.g., between presentation of a media content segment that includes an interactive assessment and receipt of any mastery-indicating input from the user by the input capture device), number of user inputs corresponding to incorrect responses before a user input corresponding to a correct response, fraction of a user input (e.g., spoken input or text input) corresponding to a comparative response (e.g., a correct response or a series of expected responses), a mastery-indicating input including an audio input corresponding to a sound or spoken expression associated with human uncertainty, a mastery-indicating input including an audio input corresponding to a sound or spoken expression associated with human certainty, a mastery-indicating input (e.g., a fraction of an image) including a facial expression or physical motion associated with human uncertainty, a change (e.g., substantial change) in amplitude of the mastery-indicating input compared to an amplitude (e.g., average amplitude) of previously captured mastery-indicating inputs associated with high (e.g., relatively high) level of mastery, a mastery-indicating input (e.g., a fraction of an image) including a facial expression or physical motion associated with human certainty, receipt of a mastery-indicating input without an associated request for assistance (e.g., selection of a help option) from the user, and/or a confidence score associated with a comparison of a mastery-indicating input to a comparative standard response (e.g., by an automatic speech recognition (“ASR”) software program).

12. The computer-implemented method of claim 1, wherein the at least one mastery-indicating input comprises an individual cumulative mastery factor.

13. The computer-implemented method of claim 12, wherein the individual cumulative mastery factor comprises one or more of: cumulative individual real-time mastery probability based on all of the user's previous individual real-time mastery factors, cumulative individual real-time mastery probability based on any one individual real-time mastery factor, cumulative individual real-time mastery probability based on any two or more individual real-time mastery factors, cumulative learning exposure frequency based on a number of times the user has been presented the first subject matter, cumulative learning exposure duration based on a length of time the user has been presented the first subject matter, a length of time since the user was last presented the first subject matter, cumulative individual real-time mastery probability based on the user's previous individual real-time mastery factors occurring within a predetermined time, cumulative individual real-time mastery probability based on any one individual real-time mastery factor occurring within a predetermined time, cumulative individual real-time mastery probability based on any two or more individual real-time mastery factors occurring within a predetermined time, and/or cumulative learning exposure frequency based on a number of times the user has been presented the first subject matter within a predetermined time.

14. The computer-implemented method of claim 1 further comprising:
determining a success probability associated with the user for a second media content segment among the plurality of media content segments, wherein the second media content segment includes a second interactive assessment on a second subject matter; and
determining a success probability associated with the user for a third media content segment among the plurality of media content segments, wherein the third media content segment includes a third interactive assessment on a third subject matter,
wherein the step of selecting the subsequent media content segment comprises selecting the subsequent media content segment based at least in part on the success probability associated with the user for the second media content segment, and the success probability associated with the user for the third media content segment, and wherein the subsequent media content segment is either the second media content segment or the third media content segment.

15. The computer-implemented method of claim 14, wherein the step of determining the success probability associated with the user for the second media content segment comprises determining an individual success probability factor associated with the user for subject matter of the second media content segment; and wherein the step of determining the success probability associated with the user for the third media content segment comprises determining an individual success probability factor associated with the user for subject matter of the third media content segment.

16. The computer-implemented method of claim 15, wherein the individual success probability factor associated with the user for the subject matter of the second media content segment comprises a second individual cumulative mastery factor, and wherein the individual success probability factor associated with the user for the subject matter of the third media content segment comprises a third individual cumulative mastery factor.

17. The computer-implemented method of claim 16, wherein the second individual cumulative mastery factor comprises one or more of: cumulative individual real-time mastery probability based on all of the user's previous individual real-time mastery factors associated with the subject matter of the second media content segment, cumulative individual real-time mastery probability based on any one individual real-time mastery factor, cumulative individual real-time mastery probability based on any two or more individual real-time mastery factors, a length of time since the user was last presented the second subject matter, cumulative learning exposure frequency based on a number of times the user has been presented the second subject matter, cumulative learning exposure duration based on a length of time the user has been presented the second subject matter, cumulative individual real-time mastery probability based on the user's previous individual real-time mastery factors occurring within a predetermined time, cumulative individual real-time mastery probability based on any one individual real-time mastery factor occurring within a predetermined time, cumulative individual real-time mastery probability based on any two or more individual real-time mastery factors occurring within a predetermined time, and/or cumulative learning exposure frequency based on a number of times the user has been presented the second subject matter within a predetermined time.

18. The computer-implemented method of claim 16, wherein the third individual cumulative mastery factor comprises one or more of: cumulative individual real-time mastery probability based on all of the user's previous individual real-time mastery factors associated with the subject matter of the third media content segment, cumulative individual real-time mastery probability based on any one individual real-time mastery factor, cumulative individual real-time mastery probability based on any two or more individual real-time mastery factors, a length of time since the user was last presented the third subject matter, cumulative learning exposure frequency based on a number of times the user has been presented the third subject matter, cumulative learning exposure duration based on a length of time the user has been presented the third subject matter, cumulative individual real-time mastery probability based on the user's previous individual real-time mastery factors occurring within a predetermined time, cumulative individual real-time mastery probability based on any one individual real-time mastery factor occurring within a predetermined time, cumulative individual real-time mastery probability based on any two or more individual real-time mastery factors occurring within a predetermined time, and/or cumulative learning exposure frequency based on a number of times the user has been presented the third subject matter within a predetermined time.

19. The computer-implemented method of claim 15, wherein the individual success probability factor associated with the user for subject matter of the second media content segment comprises: a cumulative individual mastery value based on all of the user's previous individual real-time mastery factors associated with the subject matter of the second media content segment, a cumulative individual mastery value based on any one individual real-time mastery factor, a cumulative individual mastery value based on any two or more individual real-time mastery factors, a cumulative learning exposure frequency based on a number of times the user has been presented the second subject matter, a cumulative individual real-time mastery value based on the user's previous individual real-time mastery factors occurring within a predetermined time, a cumulative individual mastery value based on any one individual real-time mastery factor occurring within a predetermined time, a cumulative individual mastery value based on any two or more individual real-time mastery factors occurring within a predetermined time, and/or a cumulative learning exposure frequency based on a number of times the user has been presented the second subject matter within a predetermined time.

20. The computer-implemented method of claim 15, wherein the individual success probability factor associated with the user for subject matter of the third media content segment comprises: a cumulative individual mastery value based on all of the user's previous individual real-time mastery factors associated with the subject matter of the third media content segment, a cumulative individual mastery value based on any one individual real-time mastery factor, a cumulative individual mastery value based on any two or more individual real-time mastery factors, a cumulative learning exposure frequency based on a number of times the user has been presented the third subject matter, a cumulative individual real-time mastery value based on the user's previous individual real-time mastery factors occurring within a predetermined time, a cumulative individual mastery value based on any one individual real-time mastery factor occurring within a predetermined time, a cumulative individual mastery value based on any two or more individual real-time mastery factors occurring within a predetermined time, and/or a cumulative learning exposure frequency based on a number of times the user has been presented the third subject matter within a predetermined time.
